(19) United States
(12) Patent Application Publication
(10) Pub. No.: US 2020/0017124 A1
(43) Pub. Date: Jan. 16, 2020

(54) ADAPTIVE DRIVER MONITORING FOR ADVANCED DRIVER-ASSISTANCE SYSTEMS

(71) Applicant: SF Motors, Inc., Santa Clara, CA (US)

(72) Inventors: Jaime Camhi, Santa Clara, CA (US); Avery Jutkowitz, Santa Clara, CA (US)

(21) Appl. No.: 16/033,958

(22) Filed: Jul. 12, 2018

(51) Int. Cl. B60W 50/14; G06N 99/00; B60W 10/08; G05D 1/00; B60W 50/08

(52) U.S. Cl. CPC B60W 50/14; G06N 99/005; B60W 10/08; G05D 1/0088; B60W 50/085; B60W 2540/30; B60W 2720/106; B60W 2710/20; B60W 2710/18; B60W 2540/28; G05D 2201/0213

(57) ABSTRACT

Provided herein are systems and methods of transferring controls in vehicular settings. A vehicle control unit can have a manual mode and an autonomous mode. An environment sensing module can identify a condition to change an operational mode of the vehicle control unit from the autonomous mode to the manual mode. A behavior classification module can determine an activity type of an occupant based on data from a sensor. A reaction prediction can use a behavior model to determine, based on the activity type, an estimated reaction time between a presentation of an indication to the occupant to assume manual control of vehicular function and a state change of the operational mode from the autonomous mode to the manual mode. A policy enforcement module can apply the action based on the estimated reaction time in advance of the condition to indicate to the occupant to assume manual control.

### BACKGROUND

Vehicles such as automobiles can gather information related to vehicle operation or related to environments about the vehicle. This information can indicate a status of the vehicle or environmental conditions for autonomous driving.

### SUMMARY

The present disclosure is directed to systems and methods of transferring controls in vehicular settings. A semi-autonomous vehicle can switch between an autonomous mode and a manual mode, and can indicate to an occupant (e.g., a driver or a passenger) to assume manual control of vehicular function when switching from the autonomous mode to the manual mode. The disclosed advanced driver-assistance system (ADAS) can determine an estimated reaction time of the occupant to assume manual control in response to the indication. By determining the estimated reaction time, the disclosed ADAS can allow for improvement in vehicle functionality and increase the operability of the vehicle across various environments.

At least one aspect is directed to a system to transfer controls in vehicular settings. The system can include a vehicle control unit disposed in an electric or other type of vehicle. The vehicle control unit can control at least one of an acceleration system, a brake system, and a steering system. The vehicle control unit can have a manual mode and an autonomous mode. The system can include a sensor disposed in the electric vehicle to acquire sensory data within the electric vehicle. The system can include an environment sensing module executing on a data processing system having one or more processors. The environment sensing module can identify a condition to change an operational mode of the vehicle control unit from the autonomous mode to the manual mode. The system can include a behavior classification module executing on the data processing system. The behavior classification module can determine an activity type of an occupant within the electric vehicle based on the sensory data acquired from the sensor. The system can include a reaction prediction module executing on the data processing system. The reaction prediction can use, responsive to the identification of the condition, a behavior model to determine, based on the activity type, an estimated reaction time between a presentation of an indication to the occupant to assume manual control of vehicular function and a state change of the operational mode from the autonomous mode to the manual mode. The system can include a policy enforcement module executing on the data processing system. The policy enforcement module can apply the action based on the estimated reaction time to the occupant to assume manual control of vehicular function in advance of the condition.

At least one aspect is directed to an electric or other type of vehicle. The electric vehicle can include a vehicle control unit executing on a data processing system having one or more processors. The vehicle control unit can control at least one of an acceleration system, a brake system, and a steering system, the vehicle control unit having a manual mode and an autonomous mode. The electric vehicle can include a sensor. The sensor can acquire sensory data within the electric vehicle. The electric vehicle can include an environment sensing module executing on the data processing system. The environment sensing module can identify a condition to change an operational mode of the vehicle control unit from the autonomous mode to the manual mode. The electric vehicle can include a behavior classification module executing on the data processing system. The behavior classification module can determine an activity type of an occupant within the electric vehicle based on the sensory data acquired from the sensor. The electric vehicle can include a reaction prediction module executing on the data processing system. The reaction prediction module can use, responsive to the identification of the condition, a behavior model to determine, based on the activity type, an estimated reaction time between a presentation of an indication to the occupant to assume manual control of vehicular function and a state change of the operational mode from the autonomous mode to the manual mode. The electric vehicle can include a policy enforcement module executing on the data processing system. The policy enforcement module can apply the action based on the estimated reaction time to the occupant to assume manual control of vehicular function in advance of the condition.

At least one aspect is directed to a method of transferring controls in vehicular settings. A data processing system having one or more processors disposed in an electric or other type of vehicle can identify a condition to change an operational mode of the vehicle control unit from the autonomous mode to the manual mode. The data processing system can determine an activity type of an occupant within the electric vehicle based on the sensory data acquired from a sensor disposed in the electric vehicle. The data processing system can determine, responsive to identifying the condition, an estimated reaction time between a presentation of an indication to the occupant to assume manual control of vehicular function and a state change of the operational mode from the autonomous mode to the manual mode. The data processing system can present the action based on the estimated reaction time to the occupant to assume manual control of vehicular functions in advance of the condition.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting an example environment to transfer controls in vehicular settings;

FIG. 2 is a block diagram depicting an example system to transfer controls in vehicular settings;

FIGS. 3-5 depict line graphs each depicting a timeline of transferring controls in vehicular settings in accordance with the system as depicted in FIGS. 1 and 2, among others;

FIG. 6 is a flow diagram of an example method of transferring controls in vehicular setting; and

FIG. 7 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of transferring controls in vehicular settings. The various concepts introduced above and discussed in greater detail below may be implemented in any of numerous ways.

Described herein are systems and methods of transferring controls in vehicular settings. Vehicular settings can include vehicles, such as electric vehicles, hybrid vehicles, fossil fuel powered vehicles, automobiles, motorcycles, passenger vehicles, trucks, planes, helicopters, submarines, or vessels. A semi-autonomous vehicle can have an autonomous mode and a manual mode. In the autonomous mode, the vehicle can use sensory data of an environment about the vehicle from various external sensors to autonomously maneuver through the environment. In the manual mode, the vehicle can have an occupant (e.g., a driver) to manually operate vehicle control systems to guide the vehicle through the environment. Whether the vehicle is in the autonomous mode or the manual mode may depend on environment conditions surrounding the vehicle.

To ensure that the occupant is diligently supervising the operations and maneuvering of the vehicle, the electric vehicle (or other type of vehicle) can have an advanced driver-assistance system (ADAS) function to periodically indicate to the driver to perform an interaction within a fixed amount of time as proof of attentiveness on the part of the driver. The interaction can include, for example, touching or holding a steering wheel. The time period between each indication to perform interactions may be independent from the activities or the profile (e.g., cognitive and physical capabilities) of the driver to perform a risk assessment of the environment. In addition, the vehicle can indicate to the driver to takeover or assume manual control of vehicular function such as acceleration, steering, and braking when switching from the manual mode to the autonomous mode.

With increasing levels of autonomy in semi-autonomous vehicles, the proper functioning of such vehicles may ever more depend on the processes of the ADAS to indicate to the occupant to perform the interaction and to assume manual control of vehicular function. The indications can include an audio output, a visual output, a tactile output, or any combination thereof. In presenting such indications to the occupant, certain schemas may not factor in the activities and profile of the driver, and the environment around the vehicle. The lack of consideration of these factors can lead to a degradation in the quality of the human-computer interaction (HCI) between the occupant and the vehicle, such as loss of trust in the autonomous driving capabilities.

Furthermore, this absence can result in decreased general utility of the vehicle itself, because such schemas consider all activities and profile of the driver the same. Not considering the driver may be problematic as different types of activities and profile may impact on attentiveness. For example, while the vehicle is in autonomous mode, a driver who is looking at a smartphone and occasionally monitoring the environment may have a different level of attentiveness from another driver who is watching asleep unable to scan the outside at all. The driver who is looking at the smartphone can likely react to an indication to assume manual control of vehicular functionalities quicker than the driver who is asleep. The reactions to the presentation of the indication to assume manual control can also vary from driver to driver, thus rendering the operability of the semi-autonomous vehicle dependent on the individual driver.

To surmount the technical challenges present in such schemas, the semi-autonomous vehicles can configure the presentation of the indication to assume manual control of vehicular functionalities based on an estimated reaction time on the part of the driver. The vehicle can be equipped with a set of compartment sensors to monitor the activity of the driver within the vehicle. Through machine learning techniques, the present ADAS of the vehicle can determine an estimated reaction time to the presentation of the indication based on the activity of the driver. The machine learning techniques can involve a model correlating the activity of the driver with various reaction times. The model can start with baseline data aggregated across a multitude of drivers of reaction times for various activity types. When a condition in the environment is detected to change from the autonomous mode to the manual mode, the indication to the driver to assume manual control of vehicular function can be presented at the estimated reaction time ahead of the occurrence of the condition.

Once the driver assumes manual control of vehicular function such as steering, the vehicle can switch from the autonomous mode to the manual mode. In addition, the ADAS can identify an actual reaction time to the presentation of the indication. As more and more activity types and reaction times to the presentations of indications are measured for the individual driver within the vehicle, the ADAS can adjust the estimated reaction times in the model for various activity types. In this manner, a given driver can be summoned in a particular presentation type to assume manual control while the driver was performing a certain activity using the estimated reaction time for the driver. Over time, the model can acquire a statistically significant number of measurements and converge to a more accurate reaction time for the particular driver for various activity types.

By taking into account the environment and the activities and profile of the particular driver in determining the estimated reaction time, the ADAS can improve the quality of the HCI between the individual driver and the vehicle. For example, rather than periodically indicating to the driver to perform an interaction within a fixed amount of time as proof of attentiveness, the ADAS can present an indication to call the driver to attention at the estimated reaction time in advance of the condition. The elimination of the periodic indication to perform an interaction within a fixed amount of time can improve the efficiency and utility of the autonomous and manual modes of the vehicle. Now, the driver of the vehicle can perform other tasks within the vehicle while the in the autonomous mode, and can turn attention to operating the vehicular controls when summoned to assume manual control. Additionally, by constraining the presentation of the indication to assume manual controls using the estimated reaction time in advance of the condition, consumption of computing resources and power can be reduced, thereby increasing the efficiency of the ADAS.

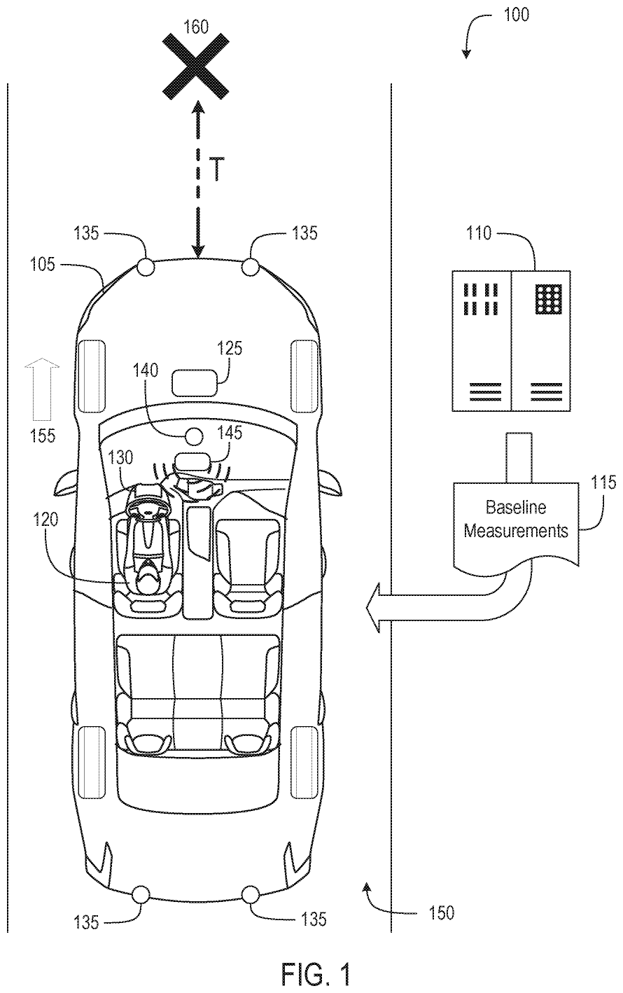

FIG. 1 depicts a block diagram of an example environment 100 to transfer controls in vehicular settings. The environment 100 can include at least one vehicle 105 such as an electric vehicle 105 on a driving surface 150 (e.g., a road) and a remote server 110. The vehicle 105 may include, for example, electric vehicles, fossil fuel vehicles, hybrid vehicles, automobiles (e.g., a passenger sedan, a truck, a bus, or a van), motorcycles, or other transport vehicles such as airplanes, helicopters, locomotives, or watercraft. The vehicle 105 can be autonomous or semiautonomous, or can switch between autonomous, semi-autonomous, or manual modes of operation. The vehicle 105 (which can also be referred to herein by reference to the example of an electric vehicle 105) can be equipped with or can include at least one advanced driver-assistance system (ADAS) 125 (that can be referred to herein as a data processing system), driving controls 130 (e.g., a steering wheel, an accelerator pedal, and a brake pedal), environmental sensors 135, compartment sensors 140, and user interfaces 145, among other components. The ADAS 125 can include one or more processors and memory disposed throughout the vehicle 105 or remotely operated from the vehicle 105, or in any combination thereof. The vehicle 105 can also have one or more occupants 120 seated or located in a passenger compartment. The environmental sensors 135 and the compartment sensors 140 can be referred to herein as sensors. An occupant 120 generally located in the seat in front of the driving controls 130 as illustrated in FIG. 1 can be referred to herein as a driver. Other occupants 120 located in other parts of the passenger compartment can be referred to herein as passengers. The remote server 110 can be considered outside the environment 100 through which the vehicle 105 is navigating.

The ADAS 125 can initially be in an autonomous mode, maneuvering the driving surface 150 in the environment 100 in a direction of travel 155 using data acquired from the environmental sensors 135 about the electric or other type of vehicle 105. Sometime during the autonomous mode, the ADAS 125 can identify at least one condition 160 based on the data acquired from the environmental sensors 135. The ADAS 125 can apply various pattern recognition techniques to identify the condition 160. Responsive to the identification of the condition 160, the ADAS 125 can change the operational mode of the electric vehicle 105 from the autonomous mode to the manual mode. The condition 160 can be in the direction of travel 155 relative to the electric vehicle 105 (e.g., forward as depicted). For example, the condition 160 can include a junction (e.g., an intersection, a roundabout, a turn lane, an interchange, or a ramp) or an obstacle (e.g., a curb, sinkhole, barrier, pedestrians, cyclists, or other vehicles) on the driving surface 150 in the direction of travel 155. The junction or the obstacle on the driving surface 150 can be identified by the ADAS 125 by applying image object recognition techniques on data acquired from cameras as examples of the environmental sensors 135. The condition 160 can be independent of the direction of travel 155 relative to the electric vehicle 105. For example, the condition 160 can include a presence of an emergency vehicle (e.g., an ambulance, a fire truck, or a police car) or another road condition (e.g., construction site) in the vicinity of the electric vehicle 105 (e.g., up to 10 km) independent of the direction of travel 155. The presence of the emergency vehicle or other road condition can be identified by the ADAS 125 by detecting a signal transmitted from the emergency vehicle or road condition. The ADAS 125 can also calculate a time T from the present to the occurrence of the condition 160 based on current speed and the direction of travel 155.

With the identification of the condition 160, the ADAS 125 can determine an activity of the occupant 120 using data acquired from the compartment sensors 140 within the passenger compartment. Based on the activity, the ADAS 125 can use a behavior model to determine an estimated reaction time of the occupant 120 between a presentation of an indication to assume manual control and assumption of the manual control of driving controls 130 by the occupant 120. The behavior model can be initially trained using baseline measurements 115 transmitted via a network connection to the ADAS 125 of the electric vehicle 105. The baseline measurements 115 can include measured reaction times of subjects to various presentations of the indications (e.g., sound, visual, or tactile stimuli) when the subject is performing a certain activity type. Through the user interface 145, the ADAS 125 can present the indication to the occupant 120 based on the estimated reaction time in advance of the condition 160. For example, the user interface 145 can present audio stimuli, visual stimuli, haptic, or tactile stimuli, or any combination thereof to call the occupant 120 to assume manual control of the driving controls 130 of the electric vehicle 105.

When the occupant 120 assumes manual control of the driving controls 130, the ADAS 125 can switch from the autonomous mode to the manual mode, relying on driver input to maneuver the electric vehicle 105 through the environment 100. The ADAS 125 can also measure an actual response time of the occupant 120 to the presentation of the indication via the user interface 145. For example, the ADAS 125 can use tactile sensors on the steering wheel to detect that the occupant 120 has made contact with the steering wheel to assume manual control of the vehicle controls. The actual response time may be greater than or less than the estimated reaction time determined using the behavior model for the occupant 120 with the determined activity. Using the actual response time and the determined activity, the ADAS 125 can adjust or modify the behavior model to produce modified estimated reaction times for the same activity. As more and more measurements are acquired, the estimated reaction times determined by the ADAS 125 using the behavior model may become more accurate to the particular occupant 120 of the electric vehicle 105.

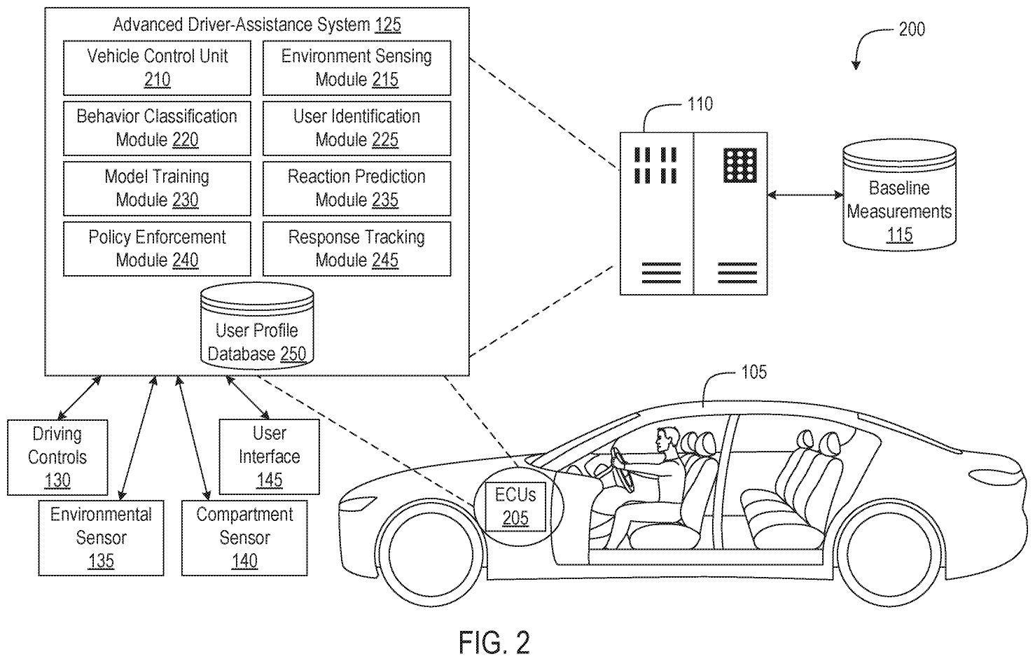

FIG. 2 depicts a block diagram of an example system 200 to transfer controls in vehicular settings. The system 200 can include one or more of the components of the environment 100 as shown in FIG. 1. The system 200 can include at least one electric vehicle 105, at least one remote server 110, and at least one advanced driver-assistance system (ADAS) 125. The electric vehicle 105 can be equipped or installed with or can otherwise include at least one driving controls 130, one or more environmental sensors 135, one or more compartment sensors 140, and one or more user interfaces 145, and one or more electronic control units (ECUs) 205. The ADAS 125 can include one or more processors, logic array, and memory to execute one or more computer-readable instructions. In overview, the ADAS 125 can include at least one vehicle control unit 210 to control maneuvering of the electric vehicle 105. The ADAS 125 can include at least one environment sensing module 215 to identify the condition 160 using data acquired from the environmental sensors 135. The ADAS 125 can include at least one behavior classification module 220 to determine an activity type of the occupants 120 using data acquired from the compartment sensors 140. The ADAS 125 can include at least one user identification module 225 to identify which user profile the occupant 120 corresponds to using the data acquired from the compartment sensors 140. The ADAS 125 can include at least one model training module 230 to train a behavior model for determining an estimated reaction time of the occupant 120 using a training dataset. The ADAS 125 can include at least one reaction prediction module 235 to use the behavior model to determine the estimated reaction time of the occupant 120 based on the determined activity type of the occupant 120. The ADAS 125 can include at least one policy enforcement module 240 to present the indication to assume manual control of vehicle controls based on the estimated reaction time. The ADAS 125 can include at least one response tracking module 245 to determine a measured reaction time between the presentation of the indication and the manual assumption of vehicle controls by the occupant 120. The ADAS 125 can include at least one user profile database 250 to maintain a set of user profiles for registered occupants 120.

Each of the components or modules of the system 200 can be implemented using hardware or a combination of software and hardware. Each component in the remote server 110, the ADAS 125, and the ECUs 205 can include logical circuity (e.g., a central processing unit) that responses to and processes instructions fetched from a memory unit. Each electronic component of the remote server 110, the ADAS 125, and the ECUs 205 can receive, retrieve, access, or obtain input data from the driving controls 130, the environmental sensors 135, the compartment sensors 140, and the user interface 145, and to each other, among others. Each electronic component of the remote server 110, the ADAS 125, and the ECUs 205 can generate, relay, transmit, or provide output data to the driving controls 130, the environmental sensors 135, the compartment sensors 140, and the user interface 145, and to each other, among others. Each electronic component of the remote server 110, the ADAS 125, and the ECUs 205 can be provided by a microprocessor unit. Each electronic component of the remote server 110, the ADAS 125, and the ECUs 205 can be based on any of these processors, or any other processor capable of operating as described herein. The central processing unit can utilize instruction level parallelism, thread level parallelism, different levels of cache, and multi-core processors. A multi-core processor can include two or more processing units on a single computing component.

The one or more ECUs 205 can be networked together for communicating and interfacing with one another. Each ECU 205 can be an embedded system that controls one or more of the electrical system or subsystems in a transport vehicle. The ECUs 205, (e.g., automotive computers) can include a processor or microcontroller, memory, embedded software, inputs/outputs and communication link(s) to run the one or more components of the ADAS 125 among others. The ECUs 205 can be communicatively coupled with one another via wired connection (e.g., vehicle bus) or via a wireless connection (e.g., near-field communication). Each ECU 205 can receive, retrieve, access, or obtain input data from the driving controls 130, the environmental sensors 135, the compartment sensors 140, the user interface 145, and the remote server 110. Each ECU 205 can generate, relay, or transmit, or provide output data to the driving the driving controls 130, the environmental sensors 135, the compartment sensors 140, the user interface 145, and the remote server 110. Each ECU 205 can involve hardware and software to perform the functions configured for the module. The various components and modules the ADAS 125 can be implemented across the one or more ECUs 205.

Various functionalities and subcomponents of the ADAS 125 can be performed in a single ECU 205. Various functionalities and subcomponents of the ADAS 125 can be split between the one or more ECUs 205 disposed in the electric vehicle 105 and the remote server 110. For example, the vehicle control unit 210 can be implemented on one or more ECUs 205 in the electric vehicle 105, while the model training module 230 can be performed by the remote server 110 or the one or more ECUs 205 in the electric vehicle 105. The remote server 110 can be communicatively coupled with, can include or otherwise access a database storing the baseline measurements 115.

The remote server 110 can include at least one server with one or more processors, memory, and a network interface, among other components. The remote server 110 can include a plurality of servers located in at least one data center, a branch office, or a server farm. The remote server 110 can include multiple, logically-grouped servers and facilitate distributed computing techniques. The logical group of servers may be referred to as a data center, server farm or a machine farm. The servers can be geographically dispersed. A data center or machine farm may be administered as a single entity, or the machine farm can include a plurality of machine farms. The servers within each machine farm can be heterogeneous: one or more of the servers or machines can operate according to one or more type of operating system platform. The remote server 110 can include servers in a data center that are stored in one or more high-density rack systems, along with associated storage systems, located for example in an enterprise data center. The remote server 110 with consolidated servers in this way can improve system manageability, data security, the physical security of the system, and system performance by locating servers and high performance storage systems on localized high performance networks. Centralization of all or some of the remote server 110 components, including servers and storage systems, and coupling them with advanced system management tools, allows more efficient use of server resources, which saves power and processing requirements and reduces bandwidth usage. Each of the components of the remote server 110 can each include at least one processing unit, server, virtual server, circuit, engine, agent, appliance, or other logic device such as programmable logic arrays configured to communicate with other computing devices, such as the ADAS 125, the electric vehicle 105, and the one or more ECUs 205 disposed in the electric vehicle 105. The remote server 110 can receive, retrieve, access, or obtain input data from the driving controls 130, the environmental sensors 135, the compartment sensors 140, the user interface 145, and the one or more ECUs 205. The remote server 110 can generate, relay, or transmit, or provide output data to the driving the driving controls 130, the environmental sensors 135, the compartment sensors 140, the user interface 145, and the one or more ECUs 205.

The ECUs 205 of the electric vehicle 105 can be communicatively coupled with the remote server 110 via a network. The network can include computer networks such as the internet, local, wide, near field communication, metro or other area networks, as well as satellite networks or other computer networks such as voice or data mobile phone communications networks, and combinations thereof. The network can include or constitute an inter-vehicle communications network, e.g., a subset of components including the ADAS 125 and components thereof for inter-vehicle data transfer. The network can include a point-to-point network, broadcast network, telecommunications network, asynchronous transfer mode network, synchronous optical network, or a synchronous digital hierarchy network, for example. The network can include at least one wireless link such as an infrared channel or satellite band. The topology of the network can include a bus, star, or ring network topology. The network can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols. The network between the ECUs 205 in the electric vehicle 105 and the remote server 110 can be periodically connected. For example, the connection may be limited to when the electric vehicle 105 is connected to the internet via a wireless modem installed in a building.

The one or more environmental sensors 135 can be used by the various components of the ADAS 125 to acquire sensory data on the environment 100 about the electric vehicle 105. The sensory data can include any data acquired by the environmental sensor 135 measuring a physical aspect of the environment 100, such as electromagnetic waves (e.g., visual, infrared, violet, and radio waves). The one or more environmental sensors 135 can include a global position system (GPS) unit, a camera (visual spectrum, infrared, or ultraviolet), a sonar sensor, a radar sensor, a light detection and ranging (LIDAR) sensor, and an ultrasonic sensor, among others. The one or more environmental sensors 135 can be also used by the various components of the ADAS 125 to sense or interface with other components or entities apart from the electric vehicle 105 via an vehicular ad-hoc network established with the other components or entities. The one or more environmental sensors 135 can include a vehicle-to-everything (V2X) unit, such as a vehicle-to-vehicle (V2V) sensor, a vehicle-to-infrastructure (V2I) sensor, a vehicle-to-device (V2D) sensor, or a vehicle-to-passenger (V2D) sensor, among others. The one or more environmental sensors 135 can be used by the various components of the ADAS 125 to acquire data on the electric vehicle 105 itself outside the passenger compartment. The one or more environmental sensors 135 can include a tire pressure gauge, a fuel gauge, a battery capacity measurer, a thermometer, an inertial measurement unit (IMU) (including a speedometer, an accelerator meter, a magnetometer, and a gyroscope), and a contact sensor, among others.

The one or more environmental sensors 135 can be installed or placed throughout the electric vehicle 105. Some of the one or more environmental sensors 135 can be installed or placed in a front portion (e.g., under a hood or a front bumper) of the electric vehicle 105. Some of the one or more environmental sensors 135 can be installed or placed in on a chassis or internal frame of the electric vehicle 105. Some of the one or more environmental sensors 135 can be installed or placed in a back portion (e.g., trunk or a back bumper) of the electric vehicle 105. Some of the one or more environmental sensors 135 can be installed or placed in on a suspension or steering system by the tires of the electric vehicle 105. Some of the one or more environmental sensors 135 can be placed on an exterior of electric vehicle 105. Some of the one or more environmental sensors 135 can be placed in the passenger compartment of the electric vehicle 105.

With cameras, as an example of the environmental sensors 135, multiple cameras can be placed throughout an exterior of the electric vehicle 105 can face any direction (e.g., forward, backward, left, and right). The cameras can include camera systems configured for medium to high ranges, such as in the area between 80 m to 300 m. Medium range cameras can be used to warn the driver about cross-traffic, pedestrians, emergency braking in the car ahead, as well as lane and signal light detection. High range cameras are used for traffic sign recognition, video-based distance control, and road guidance. A difference between cameras for medium and high range can be the aperture angle of the lenses or field of view. For medium range systems, a horizontal field of view of 70° to 120° can be used, whereas cameras with a wide range of apertures can use horizontal angles of approximately 35°. The cameras can provide the data to the ADAS 125 for further processing.

With radar sensors, as an example of the environmental sensors 135, the radar sensors can be placed on a roof of the electric vehicle 105. The radar can transmit signal within a frequency range. The radar can transmit signals with a center frequency. The radar can transmit signals that include an up-chirp or down-chirp. The radar can transmit bursts. For example, the radar can be based on 24 GHz or 77 GHz. The 77 GHZ radar can provide higher accuracy for distance and speed measurements as well as more precise angular resolution, relative to the 24 GHz radar. The 77 GHz can utilize a smaller antenna size and may have lower interference problems as compared to a radar configured for 24 GHz. The radar can be a short-range radar (“SRR”), mid-range radar (“MRR”) or long-range radar (“LRR”). SRR radars can be configured for blind spot detection, blind spot monitoring, lane and lane-change assistance, rear end radar for collision warning or collision avoidance, park assist, or cross-traffic monitoring.

The SSR sensor can complement or replace ultrasonic sensors. SRR sensors can be placed at each corner of the electric vehicle 105, and a forward-looking sensor for long range detection can be positioned on the front of the electric vehicle 105. Extra sensors are placed on each side mid-body of the electric vehicle 105. SRR sensors can include radar sensors that use the 79-GHz frequency band with a 4-GHZ bandwidth, or 1 GHZ bandwidth at 77 GHz, for example. The radar sensor can include or utilize a monolithic microwave integrated circuit (“MIMIC”) having, for example, three transmission channels (TX) and four receive channel (RX) to be monolithically integrated. The radar can provide raw data or pre-processed data to the ADAS 125. For example, the radar sensor can provide pre-process information on speed, distance, signal strength, horizontal angle, and vertical angle for each detected object. The raw data radar sensor can provide unfiltered raw data to the ADAS 125 for further processing.

With LIDAR sensors, as an example of the environmental sensors 135, the LIDAR sensors can be placed throughout an exterior of the electric vehicle 105. LIDAR sensor can refer to or include a laser-based system. In addition to the transmitter (laser), the LIDAR sensor system can use a sensitive receiver. The LIDAR sensor can measure distances to stationary as well as moving objects. The LIDAR sensor system can provide three-dimensional images of the detected objects. LIDAR sensors can be configured to provide 360 degree all-round visibility that capture spatial images of objects. LIDAR sensors can include infrared LIDAR systems that use Micro-Electro-Mechanical System (“MEMS”), a rotating laser, or a solid-state LIDAR. The LIDAR sensors can recognize light beams emitted as well as reflected from objects. For example, the LIDAR sensors can use detectors that are configured to measure single photons, such as a Single-Photon Avalanche Diode (“SPAD”).

The one or more compartment sensors 140 can be used by the various components of the ADAS 125 to acquire data within the passenger compartment of the electric vehicle 105. The data can include any data acquired by the compartment sensor 140 measuring a physical aspect of the passenger compartment of the electric vehicle 105, such as electromagnetic waves (e.g., visual, infrared, violet, and radio waves). The one or more compartment sensors 140 can share or can include any of those of the environmental sensors 135. For example, the one or more compartment sensors 140 can include a camera (visual spectrum, infrared, or ultraviolet), a light detection and ranging (LIDAR) sensor, a sonar sensor, an ultrasonic sensor, a tactile contact sensor, a weight scale, a microphone, and biometric sensor (e.g., fingerprint reader and retinal scanner) among others. The one or more compartment sensors 140 can include interfaces with auxiliary components of the electric vehicle 105, such as the temperature controls, seat controls, entertainment system, and GPS navigation systems, among others. The one or more compartment sensors 140 can face or can be directed at a predefined location in the passenger compartment of the electric vehicle 105 to acquire sensory data. For example, some of the one or more compartment sensors 140 can be directed at the location generally in front of the driving controls 130 (e.g., at the driver). Some of the one or more compartment sensors 140 can be directed at a corresponding seat within the passenger compartment of the electric vehicle 105 (e.g., at the other passengers). The one or more compartment sensors 140 can be installed or placed throughout the electric vehicle 105. For instance, some of the one or more compartment sensors 140 can be placed throughout the passenger compartment within the electric vehicle 105.

With cameras, as an example of the compartment sensors 140, multiple cameras can be placed throughout an interior of the electric vehicle 105 can face any direction (e.g., forward, backward, left, and right). The cameras can include camera systems configured for near ranges, such as in the area up to 4 m. Data acquired from the near range cameras can be used to perform face detection, facial recognition, eye gaze tracking, and gait analysis, among other techniques, of the one or more occupants 120 within the electric vehicle 105. The data acquired from the near range cameras can be used to perform edge detection, object recognition, among other techniques, of any object including the occupants 120 within the electric vehicle 105. Multiple cameras can be used to perform stereo camera techniques. The cameras can provide the data to the ADAS 125 for further processing.

The one or more user interfaces 145 can include input and output device to interface with various components of the electric vehicle 105. The user interface 145 can include a display, such as a liquid crystal display, or active matrix display, for displaying information to the one or more occupants 120 of the electric vehicle 105. The user interface 145 can also include a speaker for communicating audio input and output with the occupants 120 of the electric vehicle 105. The user interface 145 can also include a touchscreen, a cursor control, and keyboard, among others, to receive user input from the occupants 120. The user interface 145 can also include a haptic device (e.g., on the steering wheel or on the seat) to tactilely communicate information (e.g., using force feedback) to the occupants 120 of the electric vehicle 105. The functionalities of the user interfaces 145 in conjunction with the ADAS 125 will be detailed herein below.

The vehicle control unit 210 can control the maneuvering of the electric vehicle 105 through the environment 100 on the driving surface 150. The maneuvering of the electric vehicle 105 by the vehicle control unit 210 can be controlled or set via a steering system, an acceleration system, and a brake system, among other components of the electric vehicle 105. The vehicle control unit 210 can interface the driving controls 130 with the steering system, the acceleration system, and the brake system, among other components of the electric vehicle 105. The driving controls 130 can include a steering wheel for the steering system, an accelerator pedal for the acceleration system, and a brake pedal for the brake system, among others. The steering system can control the direction of travel 155 of the electric vehicle 105 by, for example, adjusting an orientation of the front wheels of the electric vehicle 105. The acceleration system can maintain, decrease, or increase a speed of the electric vehicle 105 along the direction of travel 155, for example, by to adjusting power input into the engine of the electric vehicle 105 to change a frequency of rotations of the one or more wheels of the electric vehicle 105. The brake system can decrease the speed of the electric vehicle 105 along the direction of travel 155 by applying friction to inhibit motion of the wheels.

The acceleration system can control the speed of the electric or other vehicle 105 in motion using an engine in the vehicle 105. The engine of the vehicle 105 can generate a rotation in the wheels to move the vehicle 105 at a specified speed. The engine can include an electric, hybrid, fossil fuel powered, or internal combustion, engines, or combinations thereof. The rotations generated by the engine may be controlled by an amount of power fed into the engine. The rotations generated by the internal combustion engine can be controlled by an amount of fuel (e.g., gasoline, ethanol, diesel, and liquefied natural gas (LNG)) injected for combustion into the engine. The rotations of the engine of the acceleration system can be controlled by at least one of the ECUs 205 that can be controlled by the vehicle control unit 210 (e.g., via the accelerator pedal of the driving controls 130).

The brake system can decrease the speed of the electric or other vehicle 105 by inhibiting the rotation of the wheels of the electric vehicle 105. The brake system can include mechanical brakes and can apply friction to the rotation of the wheels to inhibit motion. Examples of mechanical brakes can include a disk brake configured to be forced against the discs of the wheels. The brake system can be electromagnetic and can apply electromagnetic induction to create resistance to the rotation of the wheels thereby inhibiting motion. The brake system 150 can include at least one of the ECUs 205 that can be controlled by the vehicle control unit 210 (e.g., via the brake pedal of the driving controls 130).

The steering system can control a heading of the electric vehicle 105 by adjusting an angle of the wheels of the electric vehicle 105 relative to the driving surface 150. The steering system can include a set of linkages, pivots, and gears, such as a steering column, a line actuator (e.g., rack and pinion), a tie rod, and a king pin to connect to the wheels of the electric vehicle 105. The steering system can also translate rotation of the steering wheel of the driving controls 130 onto the line actuator and the tie rod to adjust the angling of the wheels of the electric vehicle 105. The steering system can include at least one of the ECUs 205 that can be controlled by the vehicle control unit 210 (e.g., via the steering wheel of the driving controls 130).

The vehicle control unit 210 can have or operate in an autonomous mode or a manual mode to maneuver the electric vehicle 105, among others. In the autonomous mode, the vehicle control unit 210 can use data acquired from the one or more environmental sensors 135 to navigate the electric vehicle 105 through the environment 100. For example, the vehicle control unit 210 can apply pattern recognition techniques, such as computer vision algorithms, to detect the driving surface 150 itself (e.g., boundaries and width) and objects in the driving surface 150, and control steering, acceleration, and application brakes based on the output of the pattern recognition techniques. In the manual mode, the vehicle control unit 210 can rely on user input received via the driving controls 130 (e.g., steering wheel, accelerator pedal, and brake pedal) from the occupant 120 to maneuver to the electric vehicle 105 through the environment 100. For example, under the manual mode, the vehicle control unit 210 can receive and translate user input via the steering wheel, accelerator pedal, or the brake pedal of the driving controls 130 to control the steering, acceleration, and application of the brakes to maneuver the electric vehicle 105. The vehicle control unit 210 can switch between the autonomous mode and the manual mode in response to a user input by the occupant 120. For example, the driver of the electric vehicle 105 can initiate the autonomous mode by pressing a command displayed on a center stack. The vehicle control unit 210 can switch between the autonomous mode and the manual mode as configured or caused by the other components of the ADAS 125. The details of the switching between the autonomous mode and the manual mode by the other components of the ADAS 125 will be detailed herein below.

Under the autonomous mode, the vehicle control unit 210 can automatically control the steering system, the acceleration system, and the brake system to maneuver and navigate the electric vehicle 105. The vehicle control unit 210 can acquire environmental data from the one or more environmental sensors 135. The vehicle control unit 210 can process the environmental data acquired from the environmental sensors 135 to perform simultaneous localization and mapping (SLAM) techniques. The SLAM technique can be performed, for example, using an extended Kalman filter. In performing the SLAM techniques, the vehicle control unit 210 can perform various pattern recognition algorithm (e.g., image object recognition) to identify the driving surface 150 (e.g., boundaries and lanes on the road). The vehicle control unit 210 can also identify one or more objects (e.g., signs, pedestrians, cyclists, other vehicles) about the electric vehicle 105 and a distance to each object from the electric vehicle 105 (e.g., using stereo camera techniques). The vehicle control unit 210 can further identify the direction of travel 155, a speed of the electric vehicle 105, and a location of the electric vehicle 105 using the environmental data acquired from the environmental sensors 135.

Based on these identifications and determinations, the vehicle control unit 210 can generate a digital map structure. The digital map data structure (also referred to herein as a digital map) can include data that can be accessed, parsed or processed by the vehicle control unit 210 for path generation through the environment 100. A three-dimensional dynamic map can refer to a digital map having three dimensions on an x-y-z coordinate plane. The dimensions can include, for example, width (e.g., x-axis), height (e.g., y-axis), and depth (e.g., z-axis). The dimensions can include, for example, latitude, longitude, and range. The digital map can be a dynamic digital map. For example, the digital map can be updated periodically or reflect or indicate a motion, movement or change in one or more objects detected using image recognition techniques. The digital map can also include non-stationary objects, such as a person moving (e.g., walking, biking, or running), vehicles moving, or animals moving. The digital map can be configured to detect the amount or type of movement and characterize the movement as a velocity vector having a speed and a direction in the three-dimensional coordinate plane established by the three-dimensional digital map structure.

The digital map can detect the amount or type of movement and characterize the movement as a velocity vector having a speed and a direction in the three-dimensional coordinate plane established by the three-dimensional digital map. The vehicle control unit 210 can update the velocity vector periodically. The vehicle control unit 210 can predict a location of the object based on the velocity vector between intermittent updates. For example, if the update period is 2 seconds, the vehicle control unit 210 can determine a velocity vector at t₀=0 seconds, and then use the velocity vector to predict the location of the object at t₁=1 second, and then place the object at the predicted location for an instance of the digital map at t₁=1 second. The vehicle control unit 210 can then receive updated sensed data at t₂=2 seconds, and then place the object on the three-dimensional digital map at the actual sensed location for t₂, as well as update the velocity vectors. The update rate can be 1 Hz, 10 Hz, 20 Hz, 30 Hz, 40Hz, 50 Hz, 100 Hz, 0.5 Hz, 0.25 Hz, or some other rate for automated navigation through the environment 100.

Using the digital map and SLAM techniques, the vehicle control unit 210 can generate a path for automated navigation through the environment 100 on the driving surface 150. The vehicle control unit 210 can generate the path periodically. The path may include a target direction of travel 155, a target speed of the electric vehicle 105, and a target location of the electric vehicle 105 navigating through the environment 100. The target direction of travel 155 can be defined using principal axes about the electric vehicle 105 (e.g., roll in longitudinal axis, pitch in lateral axis, and yaw in vertical axis). The target speed of the electric vehicle 105 can be defined relative to the current speed of the electric vehicle 105 (e.g., maintain, increase, or decrease). The target location of the electric vehicle 105 can be location at which the electric vehicle 105 is to be at next determination. Based on the generated path, the vehicle control unit 210 can set, adjust, or otherwise control the steering system, the acceleration system, and the brake system. For example, the vehicle control unit 210 can turn the wheels using the steering system toward the target direction or target location. The vehicle control unit 210 can also achiever the target speed for the electric vehicle 105 by applying the accelerator of the acceleration system to increase the speed or by applying the brakes of the brake system to decrease the speed.

Under the manual mode, the vehicle control unit 210 can rely on user input on the driving controls 130 by the occupant 120 to control the steering system, the acceleration system, and the brake system to maneuver and navigate the electric vehicle 105 through the environment 100. The driving controls 130 can include the steering wheel, the acceleration pedal, and the brake pedal, among others. The vehicle control unit 210 can receive a user input on the steering wheel from the occupant 120 (e.g., turning clockwise for rightward direction and turning counter-clockwise for leftward direction). The vehicle control unit 210 can turn the wheels using the steering system based on the user input on the steering wheel. The vehicle control unit 210 can receive a user input on the accelerator pedal. Based on the force on the accelerator pedal by the occupant 120, the vehicle control unit 210 can increase the speed of the electric vehicle 105 by causing the acceleration system to increase electric power to the engine. The vehicle control unit 210 can also receive a user input on the brake pedal. Based on the force applied on the brake pedal by the occupant 120, the vehicle control unit 210 can decrease the speed of the electric vehicle 105 by applying the brakes of the brake system to inhibit motion in the wheels.

The environment sensing module 215 can identify the condition 160 to change the operational mode of the vehicle control unit 210 based on the environmental data acquired from the environmental sensors 135. The condition 160 can correspond to any event in the environment 100 to cause the vehicle control unit 210 to change from the autonomous mode to the manual mode. The vehicle control unit 210 may initially be in the autonomous mode. For example, while driving, the occupant 120 of the electric vehicle 105 may have activated the autonomous mode to automate maneuvering of the electric vehicle 105 through the driving surface 150. The condition 160 can be related to the driving surface 150 in the direction of the travel 155 or independent of the direction of travel 155. As discussed previously, the condition 160 can include a junction (e.g., an intersection, a roundabout, a turn lane, an interchange, or a ramp) or an obstacle (e.g., a curb, construction site, sinkhole, detour, barrier, pedestrians, cyclists, or other vehicles) on the driving surface 150 in the direction of travel 155. The condition 160 can also be communicated to the electric vehicle 105. The condition 160 can include a presence of an emergency vehicle (e.g., an ambulance, a fire truck, or a police car) in the vicinity of the electric vehicle 105 (e.g., up to 10 km). The environment sensing module 215 can retrieve, receive, or acquire the environmental data from the one or more environmental sensors 135 periodically to identify the condition 160. The acquisition of the environmental data from the environmental sensors 135 can be 1 Hz, 10 Hz, 20 Hz, 30 Hz, 40Hz, 50 Hz, 100 Hz, 0.5 Hz, 0.25 Hz, or some other rate.

To identify the condition 160 on the driving surface 150, the environment sensing module 215 can perform various image recognition techniques on the environmental data acquired from the environmental sensors 135. For example, the environment sensing module 215 can receive image data from the cameras placed throughout the exterior of the electric vehicle 105. The environment sensing module 215 can apply edge detection techniques and corner detection techniques to determine the boundaries of the driving surface 150. The edge detection techniques can include a Canny edge detector, a differential edge detector, and a Sobel-Feldman operator, among others. The corner detection techniques can include a Harris operator, a Shi-Tomasi detection algorithm, and a level curve curvature algorithm. Based on the boundaries of the driving surface 150, the environment sensing module 215 can determine a presence of a junction (e.g., intersection, a roundabout, a turn lane, an interchange, or a ramp) in the direction of travel 155 relative to the electric vehicle 105. Using the determination, the environment sensing module 215 can identify a condition type (e.g., intersection, roundabout, turn lane, interchange, or ramp). The environment sensing module 215 can apply object recognition techniques to determine a presence of an obstacle (e.g., a curb, sinkhole, barrier, pedestrians, cyclists, or other vehicles) in the direction of travel 155 relative to the electric vehicle 105. The object recognition techniques can include geometric hashing, scale-invariant feature transform (SIFT), and speeded up robust features (SURF), among others. Based on the object recognition technique, the environment sensing module 215 can identify the condition type (e.g., curb, sinkhole, barrier, pedestrian, cyclist, or other vehicle). The edge detection techniques, the corner detection techniques, and the object recognition techniques can be applied to environmental data from LIDAR sensors, radar sensors, and sonar, among others. Based on the determination of the presence of the junction or obstacle, the environment sensing module 215 can identify the condition 160 to change the operational mode of the vehicle control unit 210 from the autonomous mode to the manual mode.

The environment sensing module 215 can also use stereo camera techniques to determine a distance to the condition 160 from the electric vehicle 105. The distance can be calculated from one side of the electric vehicle 105 along the direction of travel 155. For example, if the condition 160 is in front of the electric vehicle 105, the distance can be measured from the front bumper of the electric vehicle 105. The environment sensing module 215 can determine the distance to the condition 160 from the electric vehicle 105 based on the path generated using the digital map for automated navigation under the autonomous mode. With the determination of the distance to the condition 160, the environment sensing module 215 can determine an estimated time of occurrence of the condition 160 as well. The environment sensing module 215 can identify the speed of the electric vehicle 105 from the environmental data acquired from the environmental sensors 135. Based on speed of the electric vehicle 105 and the distance to the condition 160, the environment sensing module 215 can determine an estimated amount of time (labeled as Ton FIG. 1) to the occurrence of the condition 160 from the present.

The environment sensing module 215 can identify the condition 160 communicated from a source within a vicinity of the electric vehicle 105 (e.g., up to 10 km). The environment sensing module 215 can receive an indication of communicated via one of the V2X sensors. The receipt of the indication can be constrained to the transmission distance (e.g., 10 km) around the source of the indication. The source of the indication can include another vehicle, a radio base station, a smartphone, or any other V2X communication capable device. The indication can include a presence of an approaching emergency vehicle (e.g., an ambulance, a fire truck, or a police car), a presence of road outage (e.g., road construction or detour), and a broken down vehicle, among other conditions. For example, the environment sensing module 215 can receive an indication that an emergency vehicle is approaching via the vehicle-to-vehicle sensor. The indication can include an emergency vehicle type, a location of the emergency vehicle, and a speed of the emergency vehicle, among other information. Based on the receipt of the indication, the environment sensing module 215 can identify the condition 160. The environment sensing module 215 can further identify a presence of an approaching emergency vehicle as the condition type. The environment sensing module 215 can receive an indication of a road outage via the vehicle-to-infrastructure sensor. The indication can include a location of the road outage, among other information. Based on the receipt of the indication, the environment sensing module 215 can identify the condition 160. The environment sensing module 215 can identify a presence of the road outage as the condition type.

The environment sensing module 215 can determine a distance to the condition 160 communicated with the electric vehicle 105. The environment sensing module 215 can parse the indication communicated via the V2X sensors to identify the location of the condition 160. The environment sensing module 215 can identify a location of the electric vehicle 105 using the GPS sensor. Based on the location of the electric vehicle 105 and the location included in the indicator, the environment sensing module 215 can determine the distance to the condition 160 from the electric vehicle 105. With the determination of the distance to the condition 160, the environment sensing module 215 can determine an estimated time to occurrence of the condition 160 as well. The environment sensing module 215 can identify the speed of the electric vehicle 105 from the environmental data acquired from the environmental sensors 135. The environment sensing module 215 can determine the distance to the condition 160 from the electric vehicle 105 based on the path generated using the digital map for automated navigation under the autonomous mode. Based on speed of the electric vehicle 105 and the distance to the condition 160, the environment sensing module 215 can determine the estimated time (labeled as Ton FIG. 1) to the occurrence of the condition 160.

The environment sensing module 215 can identify the condition 160 within the electric vehicle 105 itself using data acquired from the environmental sensors 135. The condition 160 within the electric vehicle 105 itself can include a low fuel (e.g., less than 10% remaining), low electric charge in battery (e.g., less than 15% remaining), low tire pressure (e.g., less than 30 Psi or 2 Bar), high temperature in engine (e.g., above 200° C.), structure damage (e.g., cracked window or steering bar), or engine malfunction (e.g., broken cooling system), among others. The environmental sensors 135 used to detect or identify the condition 160 within the electric vehicle 105 can include vehicular sensors, such as the tire pressure gauge, fuel gauge, battery capacity measurer, IMU, thermometer, and contact sensor, among others. The environment sensing module 215 can compare the data measured by the vehicular sensors to a defined threshold. Using the comparison of the measurement with the defined threshold, the environment sensing module 215 can identify the condition 160. Based on which vehicular sensor, the environment sensing module 215 can identify the condition type. For example, the environment sensing module 215 can read a tire pressure of less than 25 psi. If the defined threshold for low tire pressure is 30 Psi or less, the environment sensing module 215 can identify the low tire pressure as the condition 160. As the condition 160 is currently ongoing within the electric vehicle 105, the environment sensing module 215 can determine the distance and the time to the condition 160 as null.

Based on sensory data acquired from the one or more compartment sensors 140, the behavior classification module 220 can determine an activity type of the occupant 120 within the electric vehicle 105. The activity type can indicate or identify a behavior, an action, and awareness of the occupant 120 within the electric vehicle 105. For example, using pattern recognition techniques on data acquired from the compartment sensors 140, the activity type of the occupant 120 determined by the behavior classification module 220 can include looking away, conducting a telephone conversation, reading a book, speaking to another occupant 120, applying cosmetics, shaving, eating, drinking, and napping among others. The behavior classification module 220 can determine the activity type based on a single frame corresponding to one sample of the sensory data acquired from the compartment sensors 140. The behavior classification module 220 can determine the activity type based on multiple frames corresponding to multiple samples over time of the sensory data acquired from the compartment sensors 140. As discussed above, the sensory data from the compartment sensors 140 may be of the passenger compartment of the electric vehicle 105. For example, the sensory data may include image data taken by cameras directed inward in the passenger compartment of the electric vehicle 105. The behavior classification module 220 can identify which of the compartment sensors 140 are directed to a predefined region of the passenger compartment within the electric vehicle 105. With the identification of the compartment sensors 140, the behavior classification module 220 can retrieve, select, or otherwise receive the sensory data from the compartment sensors 140 directed to the predefined region. The predefined region for the driver can generally correspond to a region within the passenger compartment having the driving controls 130, the driver's seat, and the space between. The compartment sensors 140 directed to the predefined region can acquire the sensory data of the occupant 120 corresponding to the driver of the electric vehicle 105. For example, the behavior classification module 220 can select image data of cameras pointed at the driver's seat in the electric vehicle 105. The predefined region for the passenger can generally correspond to a region within the passenger compartment outside the region for the driver.

The behavior classification module 220 can apply various pattern recognition techniques to the sensory data acquired from the compartment sensors 140. To identify the occupant 120 from the sensory data, the behavior classification module 220 can apply edge detection techniques (e.g., a Canny edge detector, a differential edge detector, and a Sobel-Feldman operator). The occupant 120 can be in the predefined region to which the compartment sensors 140 are directed. The behavior classification module 220 can identify a region of the sensory data corresponding to the occupant 120 using the edge detection techniques. The behavior classification module 220 can apply stereo camera techniques on the sensory data acquired from the compartment sensors 140 to construct a three-dimensional model of the occupant 120 in the predefined region within the electric vehicle 105.

With the identification the occupant 120 from the sensory data, the behavior classification module 220 can determine the activity type of the occupant 120 using pattern recognition techniques. Examples of pattern recognition techniques can include object recognition (e.g., geometric hashing, scale-invariant feature transform (SIFT), and speeded up robust features (SURF)). The behavior classification module 220 can extract one or more features from the sensory data acquired from the compartment sensors 140. The behavior classification module 220 can maintain a model for recognizing the activity type of the occupant 120 based on the sensory data acquired from the compartment sensors 140. The model may have been trained using a training dataset. The training dataset can include sample sensory data each labeled with the corresponding activity type. The training dataset can also include sample features extracted from sensory data each labeled with the corresponding activity type. The sample sensory data may be a single frame (e.g., an image) or multiple frames (e.g., video). For example, a sample image of a person down at a book may be labeled as “book reading” and a sample image of a person with eye closed laying down on a seat may be labeled as “sleeping.”

Using the trained model, the behavior classification module 220 can generate a score of each candidate activity type for the occupant 120 identified from the sensory data. In generating the score, the behavior classification module 220 can compare the features extracted from the sensory data with the labeled features of the training dataset. The score can indicate a likelihood that the occupant 120 is performing the activity corresponding to the activity type as determined by the model. The behavior classification module 220 can identify the activity type of the occupant 120 based on the scores of the corresponding candidate activity types. The behavior classification module 220 can identify the candidate activity type with the highest score as the activity type of the occupant 120.

In identifying the activity type of the occupant 120, the behavior classification module 220 can also use other pattern recognition techniques to extract the one or more features from the sensory data acquired from the compartment sensors 140. For example, the behavior classification module 220 can use facial detection to identify a face of the occupant 120 from the sensory data. The behavior classification module 220 can further apply facial recognition techniques to identify one or more facial features (e.g., eyes, nose, lips, eyebrow, and cheeks) on the identified face of the occupant 120 from the sensory data from the compartment sensors 140. The behavior classification model 220 can also determine one or more properties for each feature identified from the occupant 120 using the facial recognition techniques. The training dataset used to train the model can include the one or more facial features and the one or more properties for each feature labeled as correlated with the activity type. Using the one or more properties for each feature and the trained model, the behavior classification module 220 can determine the activity type of the occupant 120. The behavior classification module 220 can also use eye gaze tracking to identify one or more characteristics of the eyes of the identified face of the occupant 120. The training dataset used to train the model can include one or more eye characteristics labeled as correlated with the activity type. Using the one or more identified eye characteristics and the trained model, the behavior classification module 220 can determine the activity type of the occupant 120.

The behavior classification module 220 can determine the activity type of the occupant 120 based on user interactions with auxiliary components of the electric vehicle 105, such as temperature controls, seat controls, entertainment system, and GPS navigation systems. The behavior classification module 220 can receive or identify a user interaction by the occupant 120 on the components of the electric vehicle 105. The behavior classification module 220 can identify which auxiliary component the user interaction corresponds to. The behavior classification module 220 can use the user interactions on the identified auxiliary component to adjust or set the score for the activity type, prior to identifying the activity type with the highest score. For example, the user interaction with a recline button on the seat controls may correspond to the activity type of napping. In this example, the behavior classification module 220 can increase the score for the activity type of napping based on the user interaction with the recline button on the seat controls.

Using the sensory data acquired from the one or more compartment sensors 140, the user identification module 225 can identify which occupant 120 is within the electric vehicle 105 from the user profile database 250. The user profile database 250 can maintain a list of registered occupants for the electric vehicle 105. The list of registered occupants can identify each registered occupant by: an account identifier (e.g., name, electronic mail address, or any set of alphanumeric characters) and one or more features from the sensory data associated with the registered occupant. In response to the activation of the electric vehicle 105, the user identification module 225 can initiate identification of which occupant 120 is within the predefined region for the driver within the electric vehicle 105. The predefined region for the driver can generally correspond to a region within the passenger compartment having the driving controls 130, the driver's seat, and the space between. The user identification module 225 can present a prompt for the occupant 120 for the identification. For example, the user identification module 225 can generate an audio output signal via speakers requesting the driver to position relative to one of the compartment sensors 140. Subsequent to the presentation of the prompt, the user identification module 225 can receive the sensory data from the one or more compartment sensors 140. Continuing from the previous example, the driver in response can then place his face in front of a camera for a retinal scan, place a finger onto a fingerprint reader, or speak into the microphone.

The user identification module 225 can apply pattern recognition techniques to identify which occupant 120 is within the electric vehicle 105. The user identification module 225 can extract one or more features from the sensory data acquired from the compartment sensors 140. The user identification module 225 can compare the one or more features extracted from the sensory data with the one or more features of the registered occupants maintained on the user profile database 250. Based on the comparison, the user identification module 225 can generate a score indicating a likelihood that the occupant 120 is one of the registered occupants maintained on the user profile database 250. The user identification module 225 can identify which occupant 120 is within the electric vehicle 105 in the predefined region based on the scores. The user identification module 225 can identify the registered occupant with the highest score as the occupant 120 within the electric vehicle 105 in the predefined region.

In addition, the user identification module 225 can determine a number of occupants 120 within the electric vehicle 105 based on the sensory data from the compartment sensors 140. The user identification module 225 can receive sensory data of the passenger compartment from the compartment sensors 140. The user identification module 225 can apply edge detection techniques or blob detection techniques to separate the occupants 120 from the passenger compartment components (e.g., driving controls 130, seats, seatbelts, and doors) in the sensory data acquired from the compartment sensors 140. Using the edge detection techniques or blob detection techniques, the user identification module 225 can determine a number of occupants 120 within the passenger compartment of the electric vehicle 105. The user identification module 225 can also identify a weight exerted on each seat from the weight scale on the seat. The weight exerted can correspond to an amount of force applied to the seat by an occupant 120 sitting on the seat. The user identification module 225 can compare the weight at each seat to a threshold weight. The user identification module 225 can count the number of seats with weights greater than the threshold weight as the number of occupants within the electric vehicle 105.

The user identification module 225 can also identify an occupant type for each occupant 120 within the electric vehicle 105 using the sensory data acquired from the compartment sensors 140. The occupant type can include a baby, a toddler, a child, a teenager, and an adult, among others. As discussed above, the user identification module 225 can use edge detection techniques or blob detection techniques to determine the number of occupants 120 within the electric vehicle 105. Using the edge detection techniques or blob detection techniques, the user identification module 225 can determine a size (e.g., height and width) of each occupant 120. The user identification module 225 can compare the size to a predetermine set of ranges for each occupant type. For example, a height of less than 80 cm can be for a baby, a height between 80 cm and 90 cm can be for a toddler, a height between 90 cm to 100 cm can be for a child, a height between 100 cm and 120 cm can be for a teenager, and a height above 125 cm can be for an adult. Based on the size determined from the sensory data, the user identification module 225 can determine the occupant type of each occupant 120.

The user identification module 225 can communicate or provide the list of registered occupants maintained on the user profile database 250. The user identification module 225 executing on the ADAS 125 in the electric vehicle 105 can register additional occupants. For example, the user identification module 225 can prompt new occupants 120 for registration via a touchscreen display in the electric vehicle 105. The user identification module 225 can receive an account identifier and a passcode via the user interface 145. In conjunction, the user identification module 225 can also receive the sensory data from the compartment sensors 140 from the predefined region. The predefined region for the driver can generally correspond to a region within the passenger compartment having the driving controls 130, the driver's seat, and the space between. The user identification module 225 can extract one or more features from the sensory data. The user identification module 225 can store the extracted features onto the user profile database 250 as associated with the account identifier.

In response to the ECUs 205 of the electric vehicle 105 connecting to the remote server 110 via the network, the user identification module 225 can transmit or otherwise provide the list of registered occupants maintained locally on the user profile database 250 to the remote server 110. The user identification module 225 running on the remote server 110 can store and maintain the received list of registered occupants onto the user profile database 250 on the remote server 110. Subsequently, the user identification module 225 running in the electric vehicle 105 can receive the account identifier and the passcode for a registered occupant via the user interface 145. The occupant 120 in the electric vehicle 105 may correspond to a registered occupant stored on the user profile database 250 of the remote server 106, but not the user profile database 250 of the ADAS 125. The user identification module 225 running in the electric vehicle 105 can transmit a request including the account identifier and the passcode to the remote server 110 via the network. The user identification module 225 of the remote server 110 can parse the request to identify the account identifier and the passcode. The user identification module 225 can verify the account identifier and the passcode from the request with the account identifier and the passcode maintained on the user profile database 250 on the remote server 110. In response to determining a match between the account identifier and the passcode from the request with the account identifier and the passcode on the user profile database 250, the user identification module 225 of the remote server 110 can send the one or more features for the registered occupant to the ADAS 125 on the electric vehicle 105. The user identification module 225 running in the electric vehicle 105 can store the one or more features together with the account identifier and the passcode onto the user profile database 250 maintained in the ECUs 205 in the electric vehicle 105.

The model training module 230 can maintain a behavior model for determining an estimated reaction time of the occupant 120 to a presentation of an indication to assume manual control of vehicular function. The behavior model can be an artificial neural network (ANN), a Bayesian network, a Markov model, a support vector machine model, a decision tree, and a regression model, among others, or any combination thereof. The behavior model can include one or more inputs and one or more outputs, related to each other by one or more predetermined parameters. The one or more inputs can include activity types, the condition 160, number of occupants 120 in the electric vehicle 105, the occupant types of the occupants 120, type of stimulus, and time of day, among other factors. The one or more outputs can include at least the estimated reaction time of the occupant 120 to the presentation of the indication to assume control. The predetermined parameters can correlate activity types to estimated reaction times.

The model training module 230 can train the behavior model using the baseline measurements 115 maintain on the database accessible by the remote server 110. The baseline measurements 115 can include a set of reaction times to a presentation of an indication measured from test subjects performing an activity type. The set of reaction times can be measured from the test subjects for a particular type of stimulus, such as an audio stimulus, a visual stimulus, or a tactile stimulus, or any combination thereof. The reaction times can be measured in a test environment using test subjects sensing different types of stimuli. The reaction time can correspond to an amount of time between the presentation of the indication and a performance of a designated task (e.g., holding a steering wheel or facing straightforward from the driver's seat). In measuring the reaction times, the test subject may be placed in a vehicle and may have been performing an assigned task (e.g., reading a book, looking down at a smartphone, talking to another person, napping, and dancing) prior to the presentation of the indication. The test subject may also be exposed to various auxiliary conditions while measuring the reaction times, such as number of other persons in the vehicle, the type of persons, and time of day, among other factors. By training using the baseline measurements 115, the model training module 230 can set or adjust the one or more parameters of the behavior model. The model training module 230 can repeat the training of the behavior model until the one or more parameters reach convergence.

In response to the ECUs 205 of the electric vehicle 105 connecting to the remote server 110 via the network, the model training module 230 running on the remote server 110 can transmit or provide the behavior model to the model training module 230 running in the electric vehicle 105. The model training module 230 of the remote server 110 can also provide the one or more parameters of the behavior model over the connection to the model training module 230 running on the electric vehicle 105. The model training module 230 of the remote server 110 can provide the baseline measurements 115 from the database to the model training module 230 running in the electric vehicle 105. The model training module 230 running on the ECUs 205 of the electric vehicle 105 in turn can train a local copy of the behavior model using the baseline measurements 115 received from the remote server 110 via the network in the same manner as described herein. The model training module 230 running in the electric vehicle 105 can also send data to the remote server 110 to update the baseline measurements 115, as detailed herein below.

Responsive to the identification of the condition 160 to change the operational mode of the vehicle control unit 210, the reaction prediction module 235 can use the behavior model to determine an estimated reaction time of the occupant 120 based on the activity type. The estimated reaction time can correspond to an amount of time between the presentation of the indication to the occupant 120 to assume manual control of vehicular function and a state change in the operational mode from the autonomous mode to the manual mode. The state change can correspond to the occupant 120 assuming manual control of the vehicular function via the driving controls 130 for a minimum time period, such as the steering wheel, the accelerator pedal, or the brake pedal, among others. For example, the state change can correspond to the driver of the electric vehicle 105 that is currently or previously in an autonomous mode holding the steering wheel or pressing the accelerator or brake pedals for a minimum time period (e.g., 5 seconds to 30 seconds). The reaction prediction module 235 can apply the activity type of the occupant 120 as an input to the behavior model. By applying the activity type onto the one or more parameters of the behavior model, the reaction prediction module 235 can calculate or determine the estimated reaction time of the occupant 120 to the presentation of the indication to assume manual control of the vehicular function. The estimated reaction time of the occupant 120 can vary based on the activity type. For example, the estimated reaction time of the occupant 120 when previously looking at a smartphone may be longer than the estimated reaction time of the occupant 120 when previously looking to the side away from the driving controls 130.

For each type of stimulus for the presentation of the indication, the reaction prediction module 235 can generate the estimated reaction time of the occupant 120 to the type of the stimulus based on the activity type. As discussed above, the presentation of the indication can include an audio stimulus, a visual stimulus, or a tactile stimulus, or any combination thereof outputted by the user interface 145. The audio stimulus can include a set of audio signals, each of a defined time duration and an intensity. The visual stimulus can include a set of images or videos, each of a defined color, size, and time duration of display. The tactile stimulus can include an application of a force on the occupant 120, such as vibration or motion of the driving controls 130, seats, the user interface 145, or another component within the electric vehicle 105. Instructions for generating and producing audio, visual, and tactile stimuli can be stored and maintained as data files on the ADAS 125. For the same activity type, the estimated reaction times of the occupant 120 may vary based on the type of stimulus used for the presentation of the indication to assume manual control of the vehicular function. For instance, the occupant 120 when previously napping may have a shorter estimated reaction time to a tactile stimulus but a longer estimated reaction to a visual stimulus. The reaction prediction module 235 can apply the types of stimuli as inputs of the behavior model to determine the estimated reaction time of the stimulus.

Along with the activity type, the reaction prediction module 235 can use other factors as inputs to the behavior model in determining the estimated reaction time of the occupant 120 to the presentation of the indication to assume manual control of the vehicular function. The reaction prediction module 235 can use the number of occupants 120 determined to be within the electric vehicle 105 as an input to the behavior model to determine the estimated reaction time of the driver. The estimated reaction time of the driver may vary based on the number of occupants 120 within the electric vehicle 105. For example, the higher the number of occupants 120, the higher the estimated reaction time of the driver may be as the number of occupants 120 may provide additional distractions to the driver. The reaction prediction module 235 can also use the occupant types of the occupants 120 within the electric vehicle 105 as an input to the behavior model to determine the estimated reaction time of the driver. For the same activity type, the estimated reaction time of the driver may vary based on the type of occupants 120 within the electric vehicle 105. For example, if there are babies, toddlers, or children present in the electric vehicle 105, the estimated reaction time on the part of the driver may be increased due to additional distractions. The reaction prediction module 235 can use the time of day as an input to the behavior model to determine the estimated reaction time of the occupant 120. The reaction prediction module 235 can identify a time of day from a timer maintained in one of the ECUs. For the same activity type, estimated reaction time of the occupant 120 can vary. For example, a driver during night time (between 6:00 pm and 11:59 pm) may have a slower estimated reaction time than the driver during midday (between 11:00 am and 2:00 pm), due to varying levels of alertness throughout the day.

The reaction prediction module 235 can maintain a plurality behavior models on a database. The database can be part of the one or more ECUs 205 or can be otherwise accessible by the one or more ECUs 205. The database can be also part of the remote server 110 (e.g., on memory) or can otherwise be accessible by the remote server 110. The behavior models can be modified to the reaction times and activity types of individual occupants 120 using the electric vehicle 105. Each behavior model may be for a different registered occupant for the electric vehicle 105. Each behavior model can be indexed by the account identifier for the registered occupant. The reaction prediction module 235 can identify the behavior model from the plurality of behavior models based on the identification of the occupant 120 (e.g., the driver). With the identification of the occupant 120 within the electric vehicle 105, the reaction prediction module 235 can identify the account identifier of the occupant 120. The reaction prediction module 235 can use the account identifier of the occupant 120 to find the behavior model from the plurality of behavior models. With the finding of the behavior model for the occupant 120 identified within the electric vehicle 105, the reaction prediction module 235 can apply the activity type as well as other factors as the input to determine the estimated reaction time of the occupant 120 in the manner detailed above.

Based on the estimated reaction time, the policy enforcement module 240 can present the indication to the occupant 120 to assume manual control of the vehicular function in advance of the condition 160. The policy enforcement module 240 can select the presentation of the indication using the estimated reaction time of the occupant 120 in accordance with an action application policy. The action application policy can be a data structure maintained on the ADAS 125 (e.g., on a database). The action application policy can specify which stimulus types to present as the indication to the occupant 120 to assume manual control of the vehicular function for ranges of estimated reaction times. The action application policy can further specify a sequence of stimuli to select based on the ranges of estimated reaction times. The sequence of stimuli can enumerate an intensity level and a time duration for the each stimulus. The sequence of stimuli can identify a file pathname for the data files used to generate and produce the audio stimuli, visual stimuli, and tactile stimuli, or any combination thereof. The intensity levels can include volume for audio stimuli, brightness for visual stimuli, and amount of force for tactile stimuli. For example, for the activity type of napping and estimated reaction times of less than 45 seconds, the action application policy can specify that an audio stimulus of low intensity is played for the first 30 seconds, then another audio stimulus of higher intensity is played for the next 10 seconds, and then a tactile stimulus together with the previous audio stimulus is applied thereafter. The policy enforcement module 240 can compare the estimated reaction time of the occupant 120 to the ranges of estimated reaction times in the action application policy. Using the comparison, the policy enforcement module 240 can select the sequence of stimuli.

The policy enforcement module 240 can determine an initiation time for the presentation of the indication based on the estimated reaction time and the estimated time until the occurrence of the condition 160. As discussed above, in response to identifying the condition, the environment sensing module 215 can determine the estimated time of the occurrence of the condition 160. The policy enforcement module 240 can subtract the estimated reaction time from the estimated time of the occurrence of the condition 160 to determine the initiation time for the presentation of the indication to the occupant 120. In addition, the policy enforcement module 240 can set or determine a buffer time (e.g. a heads-up time) based on the estimated reaction time of the occupant 120 and the estimated time of the occurrence of the condition 160. The buffer time allows for the occupant 120 to have additional time to react to the presentation of the indication to assume manual control of the vehicular function. The policy enforcement module 240 can subtract the buffer time and the estimated reaction time from the time of the occurrence of the condition 160 to determine the initiation time. In response to changes in the estimated time of the occurrence of the condition 160, the policy enforcement module 240 can adjust the initiation time for the presentation of the indication.

In accordance with the action application policy for the estimated reaction time, the policy enforcement module 240 can present the indication via the user interface 145 to the occupant 120 to assume manual control of vehicular controls. The policy enforcement module 240 can identify the selected sequence of stimuli as specified by the action application policy. The policy enforcement module 240 can find and load the data files corresponding to the sequence of stimuli. The policy enforcement module 240 can wait and hold the data files corresponding to the sequence of stimuli until the initiation time for the presentation of the indication. The policy enforcement module 240 can maintain a timer to identify a current time. The policy enforcement module 240 can compare the current time to the initiation time for presenting the indication. In response to determining that the current time is greater than or equal to the initiation time, the policy enforcement module 240 can initiate the presentation of the indication to the occupant 120 to assume manual control. The policy enforcement module 240 can also initiate generation of the stimuli according to the data files corresponding to the sequence of stimuli. For audio stimuli, the policy enforcement module 240 can play the audio stimuli via the speakers within the electric vehicle 105 to indicate to the occupant 120 to assume manual control. For visual stimuli, the policy enforcement module 240 can control lights or render on a display the visual stimuli within the electric vehicle 105 to indicate to the occupant 120 to assume manual control. For tactile stimuli, the policy enforcement module 240 can cause vibration or motion in the seats or steering wheel within the electric vehicle 105 to indicate o the occupant 120 to assume manual control.

Subsequent to initiation, the policy enforcement module 240 can continue presenting the indication via the user interface 145 for the time duration specified by the sequence of stimuli of the action application policy. The policy enforcement module 240 can parse the data files for the generation of the stimuli. By parsing the data files, the policy enforcement module 240 can identify which user interface 145 to output to stimulus to the occupant 120 based on the stimulus type. In response to identifying the stimulus type as audio, the policy enforcement module 240 can identify or select speakers for outputting the audio stimuli. In response to identifying the stimulus type as visual, the policy enforcement module 240 can identify or select displays for outputting the visual stimuli. In response to identifying the stimulus type as tactile, the policy enforcement module 240 can identify or select haptic device for outputting the force (e.g., vibration or motion).

As the indication is presented by the policy enforcement module 240 via the user interface 145, the response tracking module 245 can maintain a timer to measure or identify an amount of time elapsed since the initiation of the presentation of the indication. The response tracking module 245 can also measure or identify the amount of time elapsed since the initiation of the generation of the output of the stimuli via the user interface 145. The response tracking module 245 can identify the initiation time as determined by the policy enforcement module 240. The response tracking module 245 can wait and monitor for user input on the driving controls 130. The user input may be on the steering wheel, the acceleration pedal, or the brake pedal. For example, the driver of the electric vehicle 105 can place hands upon the steering wheel, and the tactile contact sensor in the steering wheel can sense the contacting of the hands on the steering wheel. The driver of the electric vehicle 105 can also place a foot upon the acceleration pedal or the brake pedal, and the tactile contact sensor in the pedals can sense the contact on the acceleration pedal or the brake pedal. The response tracking module 245 can detect the state change in the operational mode of the vehicle control unit 210 from the autonomous mode to the manual mode. The state change in the operational mode of the vehicle control unit 210 can correspond to the detection of the user input on the driving controls 130. The state change can correspond to a continuous detection of the user input on the driving controls 130 for a minimum period of time (e.g., 10 to 30 seconds or other range). In response to detecting the user input on the driving controls 130, the response tracking module 124 can identify a total time elapsed since the initiation of the presentation of the indication as a measured reaction time. The total time elapsed since the initiation of the presentation of the indication can represent the actual reaction time on the part of the occupant 120 in assuming manual control of the vehicular function. The vehicle control unit 210 can also enter the manual mode from the autonomous mode in response to the detection of the user input on the driving controls 130.

Using the elapsed time identified by the response tracking module 245, the policy enforcement module 240 can change the presentation of the indication via the user interface 145. The policy enforcement module 240 can compare the elapsed time to the time duration of the stimulus as specified by the sequence of stimuli in accordance with the action application policy. The policy enforcement module 240 can determine that the elapsed time is less than the time duration specified by the sequence of stimuli. In response to the determination, the policy enforcement module 240 can continue to generate and output the stimulus as specified by the sequence of stimuli. The policy enforcement module 240 can determine that the elapsed time is greater than or equal to the time duration specified by the sequence of stimuli. In response to the determination, the policy enforcement module 240 can identify or select another indication to present to the occupant 120 to assume manual control. The policy enforcement module 240 can identify the next stimulus specified by the sequence of stimuli in the action application policy. The policy enforcement module 240 can terminate the current stimulus outputted via the user interface 145. The policy enforcement module 240 can switch to the next stimulus as specified by the sequence of stimuli and generate an output of the stimulus via the user interface 145.

The policy enforcement module 240 can also compare the elapsed time with a handover-critical threshold time. The handover-critical threshold time may represent a critical time at which the occupant 120 should assume manual control of the vehicular functions prior to the occurrence of the condition. The policy enforcement module 240 can set the handover-critical threshold time based on the estimated reaction time, the buffer time, and the time of the occurrence of the condition 160. The policy enforcement module 240 can set the handover-critical threshold time to be greater than the estimated reaction time (e.g., by a predefined multiple). The policy enforcement module 240 can set the handover-critical threshold time to be greater than the estimated reaction time plus the buffer time. The policy enforcement module 240 can set the time of occurrence of the condition 160 as the handover-critical threshold time. The policy enforcement module 240 can determine that the elapsed time is less than the handover-critical threshold time. Responsive to the determination, the policy enforcement module 240 can continue presenting the indication to the occupant 120 to assume manual control of vehicular functions. The policy enforcement module 240 can determine that the elapsed time is greater than or equal to the handover-critical threshold time. Responsive to the determination, the policy enforcement module 240 can initiate an automated countermeasure procedure to transition the electric vehicle 105 into a stationary state.

To initiate the automated countermeasure procedure, the policy enforcement module 240 can invoke the vehicle control unit 210 to navigate the electric vehicle 105 to the stationary state using the environmental data acquired by the environmental sensors 135. The vehicle control unit 210 may still be in autonomous mode, as the occupant 120 has not assumed manual control of the vehicular function. Based on the digital map data structure generated using the environmental data from the environmental sensors 135, the vehicle control unit 210 can identify a location of the condition 160. Using the location of the condition 160, the vehicle control unit 210 can identify a location to transition to the electric vehicle 105 to the stationary state. For example, the location for the stationary state may include a shoulder or a stopping lane on the side of the road. The location for the stationary state may be closer to the current location of the electric vehicle 105 than the location of the condition 160.

Based on the current location of the electric vehicle 105 and the location for the stationary state in conjunction with the previously described SLAM techniques, the vehicle control unit 210 can generate a path to the location for the stationary state. The path may include a target direction of travel 155, a target speed of the electric vehicle 105, and the location for the stationary state. The vehicle control unit 210 can apply object recognition techniques to determine a presence of an obstacle (e.g., a curb, sinkhole, barrier, pedestrians, cyclists, or other vehicles) in between the current location and the location for the stationary state. The object recognition techniques can include geometric hashing, scale-invariant feature transform (SIFT), and speeded up robust features (SURF), among others. Based on the obstacles detected using the object recognition technique, the vehicle control unit 210 can change the path to the location for the stationary state. Based on the generated path, the vehicle control unit 210 can set, adjust, or otherwise control the steering system, the acceleration system, and the brake system. For example, the vehicle control unit 210 can turn the wheels using the steering system toward the target direction or target location. The vehicle control unit 210 can also achieve the target speed for the electric vehicle 105 by applying the accelerator of the acceleration system to increase the speed or by applying the brakes of the brake system to decrease the speed. In response to determining that the electric vehicle 105 is at the target location, the vehicle control unit 210 can apply the brakes of the brake system 150 to maintain the stationary state.

Using the measured reaction time identified and the activity type of the occupant 120, the model training module 230 can set, adjust, or otherwise modify the behavior model for predicting estimated reaction times. The behavior model modified by the model training module 230 can be particular to the occupant 120. The model training module 230 can maintain a reaction time log for the occupant 120. The reaction time log can include the account identifier for the occupant 120, the activity type, the estimated reaction time for the activity type, and measured reaction time for the estimated reaction time. The reaction time log may be maintained in storage at the electric vehicle 105. The model training module 230 can determine a difference between the estimated reaction time and the measured reaction time. The model training module 230 can modify the one or more parameters of the behavior model based on the difference between the estimated reaction time and the measured reaction time and the activity type. The model training module 230 can identify the one or more parameters of the behavior model for the activity type based on the estimated reaction time and the measured reaction time. The model training module 230 can determine that the estimated reaction time is greater than the measured reaction time. Based on the determination that the estimated reaction time is greater, the model training module 230 can adjust the one or more parameters of the behavior model to decrease the estimated reaction time for the determined activity type in subsequent determinations. The model training module 230 can determine that the estimated reaction time is less than the measured reaction time. Based on the determination that the estimated reaction time is less, the model training module 230 can adjust the one or more parameters of the behavior model to increase the estimated reaction time for the determined activity type in subsequent determinations. Over time, as more and more reaction times of the occupant 120 are measured for various activity types, the behavior model can be further refined and particularized to the individual occupant 120. As such, the accuracy of the estimated reaction times in subsequent determinations can be increased for the particular occupant 120.

In response to the ECUs 205 of the electric vehicle 105 connecting to the remote server 110 via the network, the model training module 230 executing in the electric vehicle 105 can transmit or provide the modified behavior model to the remote server 110. The model training module 230 can transmit or provide the one or more parameters modified based on the estimated reaction times, the measured reactions, and the activity types of the occupant 120. The model training module 230 can also provide the reaction time log to the remote server 110 via the network. The model training module 230 executing on the remote server 110 can receive the modified behavior model from the electric vehicle 105. Using the modified behavior model from the electric vehicle 105, the model training module 230 running on the remote server 110 can modify the behavior model maintained thereon. The model training module 230 can also modify the baseline measurements 115 based on the received behavior model. The model training module 230 executing on the remote server 110 can receive the one or more modified parameters from the electric vehicle 105. Using the modified behavior model from the electric vehicle 105, the model training module 230 running on the remote server 110 can modify the behavior model maintained thereon. The model training module 230 can also modify the baseline measurements 115 based on the one or more parameters. The model training module 230 executing on the remote server 110 can receive the reaction time log from the electric vehicle 105. Using the activity type, the estimated reaction times, and the measured reaction times of the reaction time log, the model training module 230 running on the remote server 110 can modify the behavior model maintained thereon. Based on the reaction time log, the model training module 230 can also modify the baseline measurements 115.

In this manner, the baseline measurements 115 can be further updated to better reflect conditions outside of testing. For example, the baseline measurements 115 may originally have been taken in an isolated environment with fewer distractions to the occupants 120 of the electric vehicle 105, partially representative real-world, runtime conditions. In contrast, the measured response times can be taken from the occupants 120 of electric vehicles 105 in real-world, runtime conditions. Real-world, runtime conditions may include distractions and other stimuli to the occupants 120 that may affect the reaction times differently from isolated conditions. With the addition of data of measured response times from the electric vehicles 105 running in real-world, runtime conditions, the baseline measurements 115 can be further updated to more increasingly reflect the real-world, runtime conditions. The addition of data from the electric vehicles 105 can also further increase the accuracy of the estimated reaction times determined using behavior models trained using the updated baseline measurements 115, thereby improving the operability of the ADAS 125.

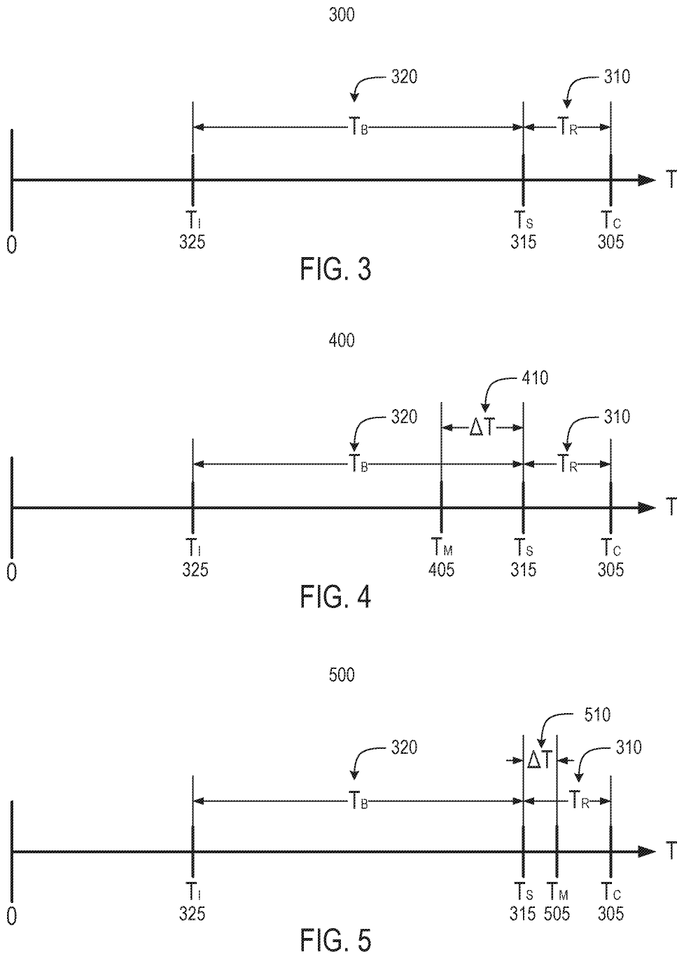

FIG. 3 depicts a line graph of a timeline 300 for transferring controls in vehicular settings in accordance with the ADAS 125 as detailed herein above in conjunction with FIGS. 1 and 2, among others. In context of the ADAS 125, the environment sensing module 215 can determine the estimated time of occurrence of the condition 160 as T_{C} 305 from the present using the sensory data acquired from the environmental sensors 135. For example, the environmental sensing module 240 can detect the occurrence of an intersection on the driving surface 150 as the condition 150 using the data acquired from the environmental sensors 135, and can calculate T_{C} 305 of 600 seconds as the estimated time of occurrence of the condition 160 from the present. In response to the identification of the condition 160, the behavior classification module 220 can determine the activity type of the occupant 120 using the sensory data acquired from the compartment sensors 140. For example, the behavior classification module 220 can determine that the driver is reading a book looking away from the driving controls 130 of the electric vehicle 105 as the activity type from a video of the driver acquired from a camera. Based on the activity type of the occupant 120 within the electric vehicle 105, the reaction prediction module 235 can determine the estimated reaction time as T_{R} 310. For example, the reaction prediction module 235 can input the determined activity type into the behavior model to calculate the estimated reaction time T_{R} 310 of 20 seconds from the present for the activity type of reading a book. The policy enforcement module 240 can subtract the estimated reaction time T_{R} 310 from the estimated time of occurrence of the condition T_{C} 305 to identify T_{S} 315. Continuing from the previous examples, the policy enforcement module 325 can calculate T_{S} 315 of 580 seconds (600−20). The policy enforcement module 240 can subtract a buffer time T_{B} 320 from Tₛ 315 to determine the initiation time T_{I} 325. For example, the buffer time T_{B} 320 can be set at 100 seconds, and thus the initiation time T_{I} 325 calculated by the policy enforcement module 240 can be 480 seconds from the present (580−100 seconds). Once at the initiation time T_{I} 325, the policy enforcement module 240 can initiate generation of the stimulus to indicate to the occupant 120 to assume manual control of the vehicular function. For example, the policy enforcement module 240 can initiate playing of an audio alert (e.g., “Please take control of steering wheel: intersection up ahead”) using transducers in the electric vehicle 105, when 480 seconds have elapsed since first identifying the condition 160.

FIG. 4 depicts a line graph of a timeline 400 for transferring controls in vehicular settings in accordance with the ADAS 125 as detailed herein above in conjunction with FIGS. 1 and 2, among others. In the context of the ADAS 125, the response tracking module 245 can identify the measured reaction time at T_{M} 405, in response to the state change in the operation mode of the vehicle control unit 210. Continuing from the example in FIG. 3, the response tracking module 245 can detect that the driver of the electric vehicle 105 started holding onto the steering wheel at T_{M} 405 of 540 seconds since first identifying the condition 160. The response tracking module 245 can determine a difference between the T_{S} 310 and the measured reaction time T_{M} 405 as ΔT 410. In the previous example, the response tracking module 245 can calculate ΔT 410 as 40 seconds (580−540 seconds). The response tracking module 245 can also determine that the ΔT 410, indicating that the estimated reaction time T_{R} 310 was an over-estimate. For the previous example, the response tracking module 245 can determine that T_{M} 405 occurred prior to T_{S} 310, and thus an over-estimate. Using the difference ΔT 410, the model training module 230 can adjust or modify the one or more parameters of the behavior model to decrease the estimated reaction times for the same activity type in subsequent determinations. For example, the model training module 230 can adjust the parameters of the behavior model for the activity type of reading a book, so that the estimated reaction time for the activity type of reading a book is decreased in future calculations.

FIG. 5 depicts a line graph of a timeline 500 for transferring controls in vehicular settings in accordance with the ADAS 125 as detailed herein above in conjunction with FIGS. 1 and 2, among others. In the context of the ADAS 125, the response tracking module 245 can identify the measured reaction time at T_{M} 505, in response to the state change in the operation mode of the vehicle control unit 210. Continuing from the example in FIG. 3, the response tracking module 245 can detect that the driver of the electric vehicle 105 started holding onto the steering wheel at T_{M} 505 of 595 seconds since first identifying the condition 160. The response tracking module 245 can determine a difference between the T_{S} 310 and the measured reaction time T_{M} 505 as ΔT 510. In the previous example, the response tracking module 245 can calculate ΔT 510 as 15 seconds (595−580 seconds). The response tracking module 245 can also determine that the ΔT 510, indicating that the estimated reaction time T_{R} 310 was an under-estimate. For the previous example, the response tracking module 245 can determine that T_{M} 505 occurred subsequent to T_{S} 310, and thus an under-estimate. Using the difference ΔT 510, the model training module 230 can adjust or modify the one or more parameters of the behavior model to increase the estimated reaction times for the same activity type in subsequent determinations. For example, the model training module 230 can adjust the parameters of the behavior model for the activity type of reading a book, so that the estimated reaction time for the activity type of reading a book is increased in future calculations.

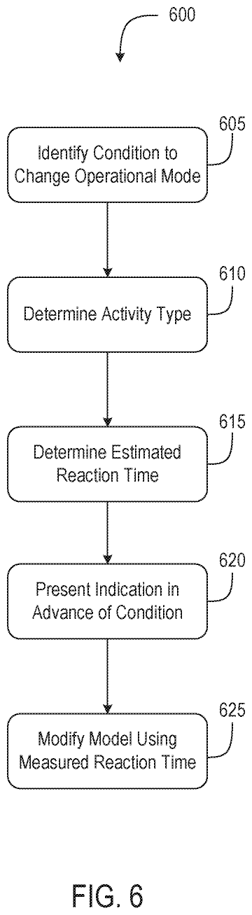

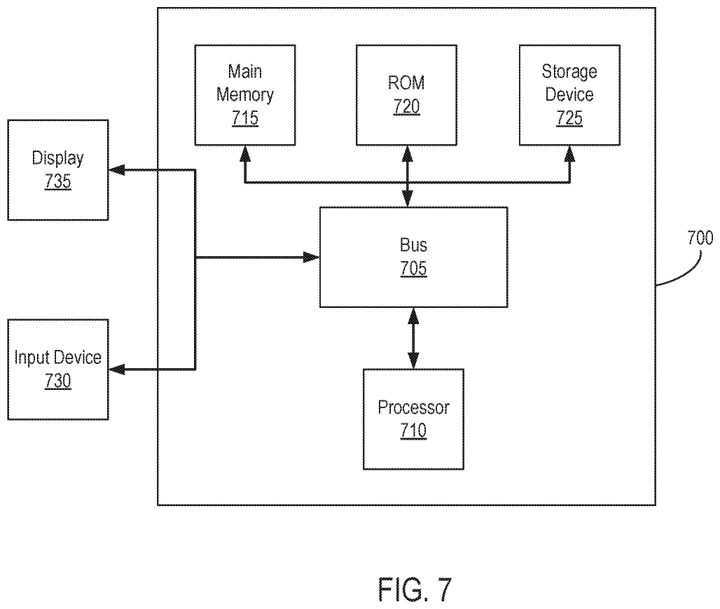

FIG. 6 depicts a flow diagram of a method 600 of transferring controls in vehicular settings. The functionalities of the method 600 may be implemented or performed by the various components of the ADAS 125 as detailed herein above in conjunction with FIGS. 1 and 2 or the computing system 700 as described herein in conjunction with FIG. 7, or any combination thereof. For example, the functionalities of the method 600 can be performed on the ADAS 125, distributed among the one or more ECUs 205 and the remote server 110 as detailed herein in conjunction with FIGS. 1 and 2. A data processing system can identify a condition to change operational mode (ACT 605). The data processing system can determine an activity type (ACT 610). The data processing system can determine an estimated reaction time (ACT 615). The data processing system can present an indication in advance of the condition (ACT 620). The data processing system can modify a model using a measured reaction time (ACT 625).

For example, a data processing system (e.g. ADAS 125) can identify a condition to change operational mode (ACT 605). The data processing system 125 can identify the condition to change from environmental data acquired from sensors about an electric vehicle. The condition can cause a vehicle control unit of the electric vehicle to change from an autonomous mode to a manual mode. The condition can be related to a driving surface upon which the electric vehicle is maneuvering or can be communicated to the electric vehicle itself. The data processing system 125 can apply various pattern recognition techniques to identify the condition from the environmental data. With the identification of the condition, the data processing system 125 can determine an estimated distance and time to the occurrence of the condition.

The data processing system 125 can determine an activity type (ACT 610). The data processing system 125 can determine the activity type of an occupant (e.g., a driver) within the electric vehicle using sensory data acquired from sensors directed at within a passenger compartment of the electric vehicle. The data processing system 125 can apply pattern recognition techniques to the sensory data to determine the activity type of the occupant. The data processing system 125 can also extract features from the sensory data, and can compare the extracted features with labeled features predetermined to correlate with various activity types. Based on the comparison, the data processing system 125 can determine the activity type of the occupant.

The data processing system 125 can determine an estimated reaction time (ACT 615). Based on the determined activity type, the data processing system 125 can use a behavior model to determine the estimated reaction time of the occupant to a presentation of an indication to assume manual control. The behavior model can include a set of inputs and a set of outputs related to the inputs based on a set of parameters. The behavior model can initially be trained using baseline measurements. The baseline measurements can indicate reaction times of test subjects to the presentations of the indication when the test subjects were performing another activity. By training, the data processing system 125 can adjust the set of parameters in the behavior model. The data processing system 125 can apply the determined activity type as an input to the behavior model to obtain the estimated reaction time as the output.

The data processing system 125 can present an indication in advance of the condition (ACT 620). The data processing system 125 can present the indication to the occupant to assume manual control of the vehicular function based on the estimated reaction time. The presentation of the indication can include audio stimuli, video stimuli, or tactile stimuli, or any combination thereof. The data processing system 125 can subtract the estimated reaction time from the time of the occurrence of the condition to determine an initiation time to present the indication. The data processing system 125 can also subtract a buffer time to further adjust the initiation time. The data processing system 125 can maintain a timer to determine a current time. Responsive to the current time matching the initiation time, the data processing system 125 can generate an output to present the indication to the occupant to assume manual control.

The data processing system 125 can modify a model using a measured reaction time (ACT 625). The data processing system 125 can identify a measured reaction time that the occupant took to assume manual control of vehicular function (e.g., grabbing a steering wheel). The data processing system 125 can compare the estimated reaction time and the measured reaction time. In response to determining that the estimated reaction time is greater than the measured reaction time, the data processing system 125 can modify the set of parameters of the behavior model to decrease estimated reaction time in subsequent determinations for the activity type. In response to determining that the estimated reaction time is less than the measured reaction time, the data processing system 125 modify the set of parameters of the behavior model to increase estimated reaction time in subsequent determinations for the activity type.

FIG. 7 depicts a block diagram of an example computer system 700. The computer system or computing device 700 can include or be used to implement the data processing system 102, or its components such as the data processing system 102. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be or include the memory 112. The main memory 715 can also be used for storing position information, vehicle information, command instructions, vehicle status information, environmental information within or external to the vehicle, road status or road condition information, or other information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions. The storage device 725 can include or be part of the memory 112.

The computing system 700 may be coupled via the bus 705 to a display 735, such as a liquid crystal display, or active matrix display, for displaying information to a user such as a driver of the electric vehicle 105. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 (e.g., on a vehicle dashboard) can be part of the data processing system 125, the user interface 145, or other component of FIG. 1 or 2, as well as part of the remote server 110, for example.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., various modules of the data processing system 125, components of the ECUs 205, and remote server 110), and illustrates one grouping of operations and responsibilities of these system components. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “data processing system” “computing device” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example, while vehicle 105 is often referred to herein by example as an electric vehicle 105, the vehicle 105 can include fossil fuel or hybrid vehicles in addition to electric powered vehicles and examples referencing the electric vehicle 105 include and are applicable to other vehicles 105. Scope of the systems and methods described herein is thus indicated by the appended claims, rather than the foregoing description, and changes that come within the meaning and range of equivalency of the claims are embraced therein.

What is claimed is:

1. A system to transfer controls in vehicular settings, comprising:
a vehicle control unit disposed in an electric vehicle to control at least one of an acceleration system, a brake system, and a steering system, the vehicle control unit having a manual mode and an autonomous mode;
a sensor disposed in the electric vehicle to acquire sensory data within the electric vehicle;
an environment sensing module executing on a data processing system having one or more processors to identify a condition to change an operational mode of the vehicle control unit from the autonomous mode to the manual mode;
a behavior classification module executing on the data processing system to determine an activity type of an occupant within the electric vehicle based on the sensory data acquired from the sensor;
a reaction prediction module executing on the data processing system to use, responsive to the identification of the condition, a behavior model to determine, based on the activity type, an estimated reaction time between a presentation of an indication to the occupant to assume manual control of a vehicular function and a state change of the operational mode from the autonomous mode to the manual mode; and
a policy enforcement module executing on the data processing system to present the indication based on the estimated reaction time to the occupant to assume manual control of the vehicular function in advance of the condition.

2. The system of claim 1, comprising:
a response tracking module executing on the data processing system to determine a measured reaction time between the presentation of the indication and the state change of the vehicle control unit; and
a model training module executing on the data processing system to modify one or more parameters of the behavior model based on the estimated reaction time, the measured reaction time, and the activity type.

3. The system of claim 1, comprising:
a model training module executing on the data processing system to maintain the behavior model including one or more parameters predetermined using baseline data, the baseline data including a plurality of reaction times measured from a plurality of test subjects to the presentation of the indication.

4. The system of claim 1, comprising:
a model training module executing on the data processing system to transmit, via a network connection, one or more parameters of the behavior model to a remote server to update baseline data, the baseline data including a plurality of reaction times measured from a plurality of test subjects.

5. The system of claim 1, comprising:
a user identification module executing on the data processing system to determine a number of occupants within the electric vehicle based on the sensory data acquired by the sensor; and
the reaction prediction module to use the behavior model to determine the estimated reaction time based on the number of occupants determined to be within the electric vehicle.

6. The system of claim 1, comprising:
a user identification module executing on the data processing system to identify, from a plurality of registered occupants, the occupant within the electric vehicle based on the sensory data acquired by the sensor; and
the reaction prediction module to select the behavior model from a plurality of behavior models based on the identification of the occupant based on the sensory data, each behavior model for a corresponding occupant of the plurality of registered occupants.

7. The system of claim 1, comprising:
a user identification module executing on the data processing system to identify an occupant type for the occupant within the vehicle based on the sensory data acquired by the sensor; and
the reaction prediction model to use the behavior model to determine the estimated reaction time based on the occupant type of the occupant within the electric vehicle.

8. The system of claim 1, comprising:
a response tracking module executing on the data processing system to compare an elapsed time since the presentation of the indication to the occupant to assume manual control of the vehicular function to a time duration for the indication; and
the policy enforcement module to select, responsive to a determination that the elapsed time is greater than the time threshold, a second indication from a plurality of indications different from the indication to present in advance of the condition.

9. The system of claim 1, comprising:
a response tracking module executing on the data processing system to compare an elapsed time since the presentation of the indication to the occupant to assume manual control of the vehicular function, the threshold time set greater than the estimated reaction time; and
the policy enforcement module to cause, responsive to a determination that the elapsed time is greater than the threshold time, an automated countermeasure procedure to transition the electric vehicle into a stationary state.

10. The system of claim 1, comprising:
the environment sensing module to determine an estimated time from present to the condition to change the operational mode of the vehicle control unit from the autonomous mode to the manual mode; and
the policy enforcement module to determine a buffer time based on the estimated reaction time of the occupant and the estimated time from the present to the condition and to initiate the presentation of the indication from the buffer time.

11. An electric vehicle, comprising:
a vehicle control unit executing on a data processing system having one or more processors to control at least one of an acceleration system, a brake system, and a steering system, the vehicle control unit having a manual mode and an autonomous mode;
a sensor to acquire sensory data within the electric vehicle;
an environment sensing module executing on the data processing system to identify a condition to change an operational mode of the vehicle control unit from the autonomous mode to the manual mode;
a behavior classification module executing on the data processing system to determine an activity type of an occupant within the electric vehicle based on the sensory data acquired from the sensor;
a reaction prediction module executing on the data processing system to use, responsive to the identification of the condition, a behavior model to determine, based on the activity type, an estimated reaction time between a presentation of an indication to the occupant to assume manual control of a vehicular function and a state change of the operational mode from the autonomous mode to the manual mode; and
a policy enforcement module executing on the data processing system to present the indication based on the estimated reaction time to the occupant to assume manual control of the vehicular function in advance of the condition.

12. The electric vehicle of claim 11, comprising:
a response tracking module executing on the data processing system to determine a measured reaction time between the presentation of the indication and the state change of the vehicle control unit; and
a model training module executing on the data processing system to modify one or more parameters of the behavior model based on the estimated reaction time, the measured reaction time, and the activity type.

13. The electric vehicle of claim 11, comprising:
a model training module executing on the data processing system to maintain the behavior model including one or more parameters predetermined using baseline data, the baseline data including a plurality of reaction times measured from a plurality of test subjects to the presentation of the indication.

14. The electric vehicle of claim 11, comprising:
a user identification module executing on the data processing system to determine a number of occupants within the electric vehicle based on the sensory data acquired by the sensor; and
the reaction prediction module to use the behavior model to determine the estimated reaction time based on the number of occupants determined to be within the electric vehicle.

15. The electric vehicle of claim 11, comprising:
a response tracking module executing on the data processing system to compare an elapsed time since the presentation of the indication to the occupant to assume manual control of the vehicular function to a time duration for the indication; and
the policy enforcement module to select, responsive to a determination that the elapsed time is greater than the time threshold, a second indication from a plurality of indications different from the indication to present in advance of the condition.

16. The electric vehicle of claim 11, comprising:
a response tracking module executing on the data processing system to compare an elapsed time since the presentation of the indication to the occupant to assume manual control of the vehicular function, the threshold time set greater than the estimated reaction time; and
the policy enforcement module to cause, responsive to a determination that the elapsed time is greater than the threshold time, an automated countermeasure procedure to transition the electric vehicle into a stationary state.

17. The electric vehicle of claim 11, comprising:
the environment sensing module to determine an estimated time from present to the condition to change the operational mode of the vehicle control unit from the autonomous mode to the manual mode; and
the policy enforcement module to determine a buffer time based on the estimated reaction time of the occupant and the estimated time from the present to the condition and to initiate the presentation of the indication from the buffer time.

18. A method of transferring controls in vehicular settings, comprising:
identifying, by a data processing system having one or more processors disposed in a vehicle, a condition to change an operational mode of the vehicle control unit from the autonomous mode to the manual mode;
determining, by the data processing system, an activity type of an occupant within the vehicle based on the sensory data acquired from a sensor disposed in the vehicle;
determining, by the data processing system, responsive to identifying the condition, an estimated reaction time between a presentation of an indication to the occupant to assume manual control of a vehicular function and a state change of the operational mode from the autonomous mode to the manual mode; and
presenting, by the data processing system, the indication based on the estimated reaction time to the occupant to assume manual control of the vehicular function in advance of the condition.

19. The method of claim 18, comprising:
determining, by the data processing system, a measured reaction time between the presentation of the indication and the state change of the vehicle control unit; and
modifying, by the data processing system, one or more parameters of the behavior model based on the estimated reaction time, the measured reaction time, and the activity type.

20. The method of claim 18, comprising:
identifying, by the data processing system, from a plurality of registered occupants, the occupant within the vehicle based on the sensory data acquired by the sensor; and
selecting, by the data processing system, the behavior model from a plurality of behavior models based on the identification of the occupant based on the sensory data, each behavior model for a corresponding occupant of the plurality of registered occupants.
